(19) United States
(12) Patent Application Publication
(10) Pub. No.: US 2018/0137415 A1
(43) Pub. Date: May 17, 2018

(54) PREDICTIVE ANALYTIC METHODS AND SYSTEMS

(71) Applicant: Minitab, Inc., STATE COLLEGE, PA (US)

(72) Inventors: Dan Steinberg, San Diego, CA (US); Nicholas Scott Cardell, Pullman, WA (US)

(73) Assignee: Minitab, Inc., STATE COLLEGE, PA (US)

(21) Appl. No.: 15/805,548

(22) Filed: Nov. 7, 2017

Related U.S. Application Data
(60) Provisional application No. 62/421,215, filed on Nov. 11, 2016.

(51) Int. Cl. G06N 3/08; G06F 15/18; G06N 7/00; G06F 17/18

(52) U.S. Cl. CPC G06N 3/08; G06F 17/18; G06N 7/005; G06F 15/18

(57) ABSTRACT

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the relationship between parts and folds may exclude some of the training data in common, with the same degree of overlap in the data between each pair of folds. Various examples may advantageously produce models built on each pair of folds having nearly equal pairwise-correlation of their predictions with models built on any other pair of folds.

### CROSS-REFERENCE TO RELATED APPLICATIONS

This application claims the benefit of U.S. Provisional Application No. 62/421,215, titled “PREDICTIVE ANALYTIC METHODS AND SYSTEMS,” filed on Nov. 11, 2016, by Dan Steinberg and Nicholas Scott Cardell.

This application incorporates the entire contents of the foregoing application herein by reference.

### TECHNICAL FIELD

Various embodiments relate generally to automatic development of learning machines and predictive analytic models.

### BACKGROUND

Learning machines are machines designed to learn. Learning machines may be designed based on machine learning principles. Machine learning is a branch of artificial intelligence, which includes computer science and learning theory. Learning machines may learn to make predictions. Some learning machines make predictions by applying input data to a predictive analytic model. Learning machines may learn to make predictions by constructing a predictive analytic model. Learning machines may construct a predictive analytic model by predictive analysis of example data. Various types of predictive analytic models may be constructed and employed by learning machines to make predictions. For example, some learning machines may construct and employ predictive analytic models including a decision tree, a random forest, an ensemble, or a Gradient Boosting Machine (GBM).

Users of learning machines and predictive analytic models include individuals, computer applications, and electronic devices. Users may employ learning machines and predictive analytic models to make predictions or decisions. A user of a learning machine or predictive analytic model may desire that the machine or model satisfy predetermined evaluation criteria. Many learning machines construct predictive analytic models based on predictive analysis of example, or training data, evaluate the predictive analytic models based on test data, and repetitively adjust model construction parameters to obtain a model satisfying predetermined evaluation criteria.

A predictive analytic model may be constructed by dividing data into subsets of at least one observation per subset, referred to as parts. The parts are divided into example, or training data parts, and test data parts. The parts assigned to the training data parts may be grouped into one or more subset of training data parts referred to as folds, and a predictive analytic model constructed for each fold. The test data parts may be used to evaluate the constructed model using a procedure known as cross-validation.

Various model construction parameters may affect the evaluation of a constructed model by cross-validation. For example, the amount of data in the training partition and the test data partition may affect the quality of the constructed model. Some models constructed based on limited training data may suffer from poor predictive accuracy. The particular assignment of training data parts to each fold for constructing each predictive analytic model, and the particular assignment of test data parts to evaluate each predictive analytic model, may affect the predictive performance of the constructed model. Evaluation of some models based on limited test parts may result in less certain evaluation of a constructed model. Obtaining a predictive analytic model satisfying predetermined evaluation criteria by repetitive construction and cross-validation may consume excessive resources and time. A user of a learning machine or predictive analytic model may be required to adjust model construction parameters many times to obtain a model acceptable based on satisfying predetermined evaluation criteria.

### SUMMARY

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the relationship between parts and folds may exclude some of the training data in common, with the same degree of overlap in the data between each pair of folds. Various examples may advantageously produce models built on each pair of folds having nearly equal pairwise-correlation of their predictions with models built on any other pair of folds.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the relationship between parts and folds may be symmetric, defining parts assigned to test each fold and test more than one fold. The symmetric relationship may be, for example, based on Galois Field mathematics. Various examples may advantageously partition data to assign parts to train and test to construct an optimal model using a minimum number of folds.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the relationship between parts and folds may be symmetric, defining parts assigned to test each fold and test more than one fold. The symmetric relationship may be, for example, based on a Latin Square. Various examples may advantageously partition data to assign parts to train and test to construct an optimal model using a minimum number of folds.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the relationship between parts and folds may be symmetric, defining parts assigned to test each fold and test more than one fold. The symmetric relationship may be, for example, based on a Latin Cube. Various examples may advantageously partition data to assign parts to train and test to construct an optimal model using a minimum number of folds.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the relationship between parts and folds may be symmetric, defining parts assigned to test each fold and test more than one fold. The symmetric relationship may be, for example, based on a Latin Hypercube. Various examples may advantageously partition data to assign parts to train and test to construct an optimal model using a minimum number of folds.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the relationship between parts and folds may be a combinatorics-based K-Choose-J approach for J parts and K folds, defining parts assigned to test each fold and test more than one fold. Various examples may advantageously partition data to assign parts to train and test to construct an optimal model using a minimum number of folds.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the relationship between parts and folds may assign parts to test each fold and test more than one fold based on leaving out each part assigned to test a prime number of times. Various examples may advantageously provide more accurate estimation of the variance of predictions for a given observation.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be evaluated based on more than one prediction per observation. The model may be evaluated based on, for example, a statistic calculated from three predictions for each observation. Various examples may advantageously evaluate a model based on more than one part left out for test in more than one fold.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be evaluated based on more than one prediction per observation. The model may be evaluated based on, for example, a statistic calculated from three predictions for each observation. Various examples may advantageously provide estimates of prediction error for a specific data record or a given terminal node of the model.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be an ensemble of the models trained on the folds. For example, the predictive analytic model may be a Gradient Boosting Machine. Various examples may provide an advantageously re-weighted ensemble of the models trained on the folds.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be an ensemble of the individual models trained on all the folds to a model-specific optimal complexity that may be individually overfit, but not overfit within an ensemble. Various examples may advantageously provide an ensemble of the models trained on the folds, with model-specific overfitting averaged out in the ensemble.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be an ensemble of the renormalized individual models trained on all the folds. Various examples may advantageously provide the estimated performance of the predictive analytic model on new data, determined for more than one prediction per test data observation, by pairs of models not trained on the observation.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient analysis of “big data” distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient analysis of rare events distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient feature selection of features distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient analysis of pharmaceutical data distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient analysis of chemical data distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient analysis of genomics data distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient analysis of bioinformatics data distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient analysis of clinical data distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and assigned to test, allowing the model in any one fold to be learned entirely on one server. Various examples may advantageously support efficient analysis of credit transaction data distributed across many servers, using a small fraction of each fold's data.

Apparatus and associated methods relate to developing a predictive analytic model based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. In an illustrative example, the predictive analytic model may be constructed and evaluated based on inverting the roles of parts assigned to training and test, allowing the model in any one fold to be learned entirely on one server. Various examples may advantageously support efficient analysis of internet advertisement click data distributed across many servers, using a small fraction of each fold's data.

Various embodiments may achieve one or more advantages. For example, some embodiments may reduce a user's effort expended to develop a predictive analytic model. This facilitation may be a result of optimal partitioning to reduce the amount of data that must be processed to construct a predictive analytic model. In some embodiments, data may be partitioned to assign parts to train and test to construct an optimal model using a minimum number of folds. Such optimal partitioning may speed up the construction and evaluation of predictive analytic models satisfying predetermined evaluation criteria. Various implementations may provide more accurate estimation of the variance of predictions for a given observation. This facilitation may be a result of evaluating the predictive analytic model based on more than one prediction determined for each observation in each test data record as a function of a predictive analytic model not trained on the test data record.

In some embodiments, the effort required by a user to construct and evaluate a predictive analytic model based on a very large data set may be reduced. For example, a user developing a predictive analytic model based on a genomics data set distributed across many servers may construct and evaluate an optimal model using only a small fraction of the data set. This facilitation may be a result of inverting the roles of parts assigned to training and assigned to test, allowing the model in any one fold to be learned entirely on one server, and evaluating the model based on more than one prediction for each test observation, by a model not trained on that observation.

In the present disclosure, various features are described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

In the present disclosure, variable names or other identification may be given to identify storage elements to facilitate discussion, and such variable names should not be understood as limiting or restrictive unless the person skilled in the art would in some case of such a variable name or other identification recognize such non-limiting or non-restricted understanding as nonsensical.

In the present disclosure, expressions in parentheses may be understood as being optional. As used in the present disclosure, quotation marks may emphasize that the expression in quotation marks may also be understood in a figurative sense. As used in the present disclosure, quotation marks may identify a particular expression under discussion.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting. In the present disclosure, all embodiments where “comprising” is used may have as alternatives “consisting essentially of,” or “consisting of” In the present disclosure, any method or apparatus embodiment may be devoid of one or more process steps or components. In the present disclosure, embodiments employing negative limitations are expressly disclosed and considered a part of this disclosure.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of the invention, even those disclosed solely in combination with other features of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of” In the present disclosure, all embodiments where “comprising” is used may have as alternatives “consisting of” In the present disclosure, all method steps using “comprising” may have as alternative steps “consisting essentially of” All method steps using “comprising” may have as alternative steps “consisting of” In the present disclosure, all apparatus components described using “comprising” may have as alternative embodiments “consisting essentially of” In the present disclosure, all apparatus components described using “comprising” may have as alternative embodiments “consisting of” In the present disclosure, any method or apparatus embodiment may be devoid of one or more process steps or components. In the present disclosure, embodiments employing negative limitations are expressly disclosed and considered a part of this disclosure.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an operational activity diagram of an exemplary learning machine developing a predictive analytic model based on data records partitioned as a function of at least one relationship between parts and folds, assigning more than one part to test each fold, and assigning at least one part to test more than one fold, such that exactly one part in common to any two folds is excluded for testing, and the part in common to any two folds excluded for testing is in the test sample for both folds; and, evaluating the predictive analytic model based on more than one prediction determined for each observation in each test data record as a function of a predictive analytic model not trained on the test data record.

FIG. 2 depicts an exemplary process flow of an exemplary Predictive Analytic Engine (PAE) developing a predictive analytic model.

FIG. 3 depicts an exemplary process flow of an exemplary Predictive Analytic Engine (PAE) developing an ensemble model.

FIG. 4 depicts a structural view of an exemplary learning machine having a Predictive Analytic Engine (PAE).

FIG. 5 depicts an exemplary process flow of an exemplary Predictive Analytic Engine (PAE) developing a predictive analytic model.

FIG. 6 depicts an exemplary process flow of an exemplary Predictive Analytic Engine (PAE) developing a predictive analytic model.

FIG. 7 depicts an exemplary process flow of an exemplary Predictive Analytic Engine (PAE) developing a predictive analytic model.

Like reference symbols in the various drawings indicate like elements.

### DETAILED DESCRIPTION OF ILLUSTRATIVE EMBODIMENTS

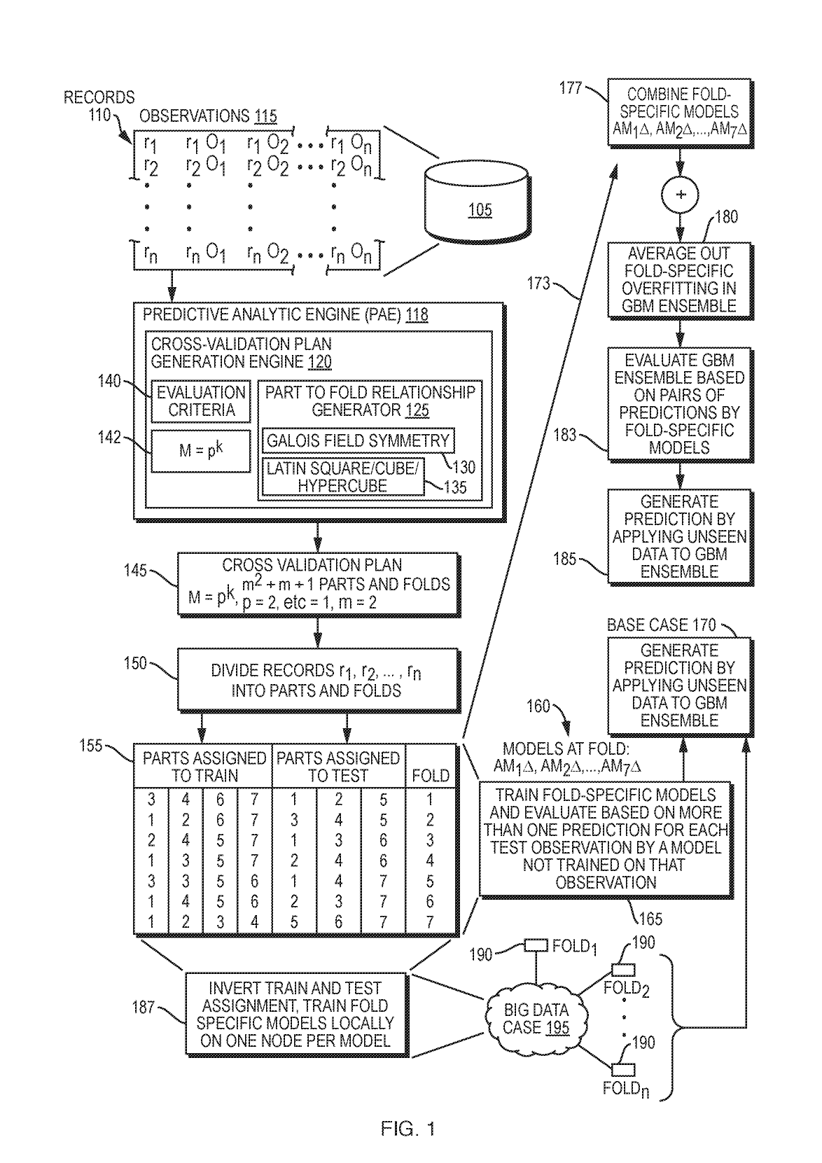

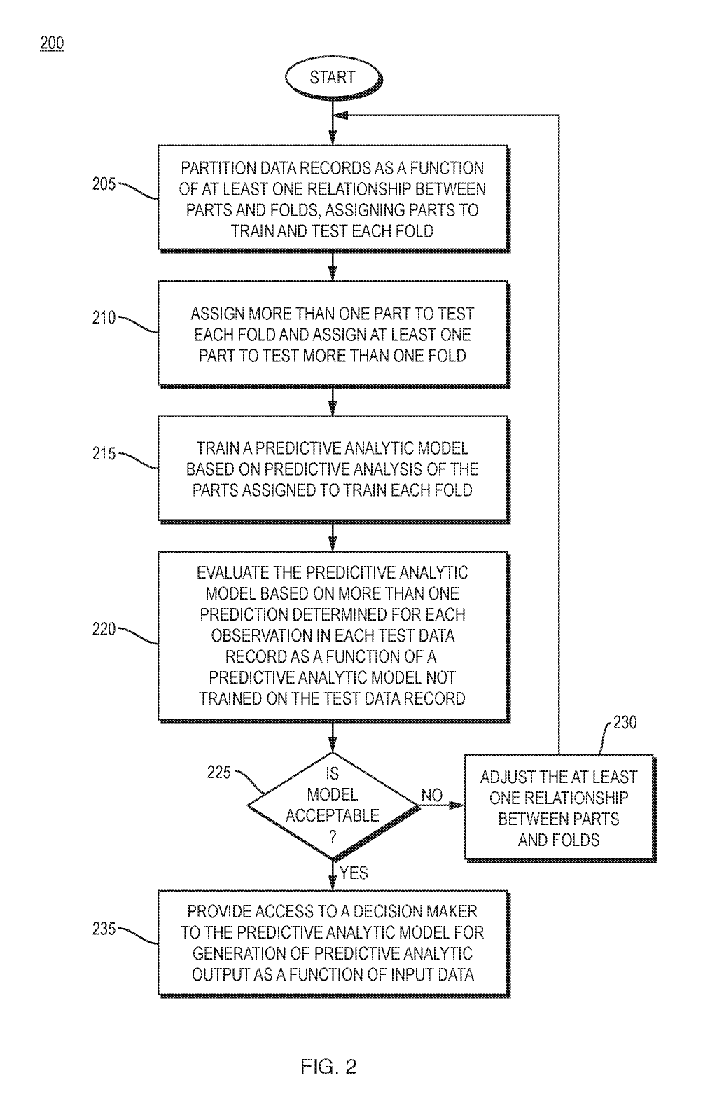

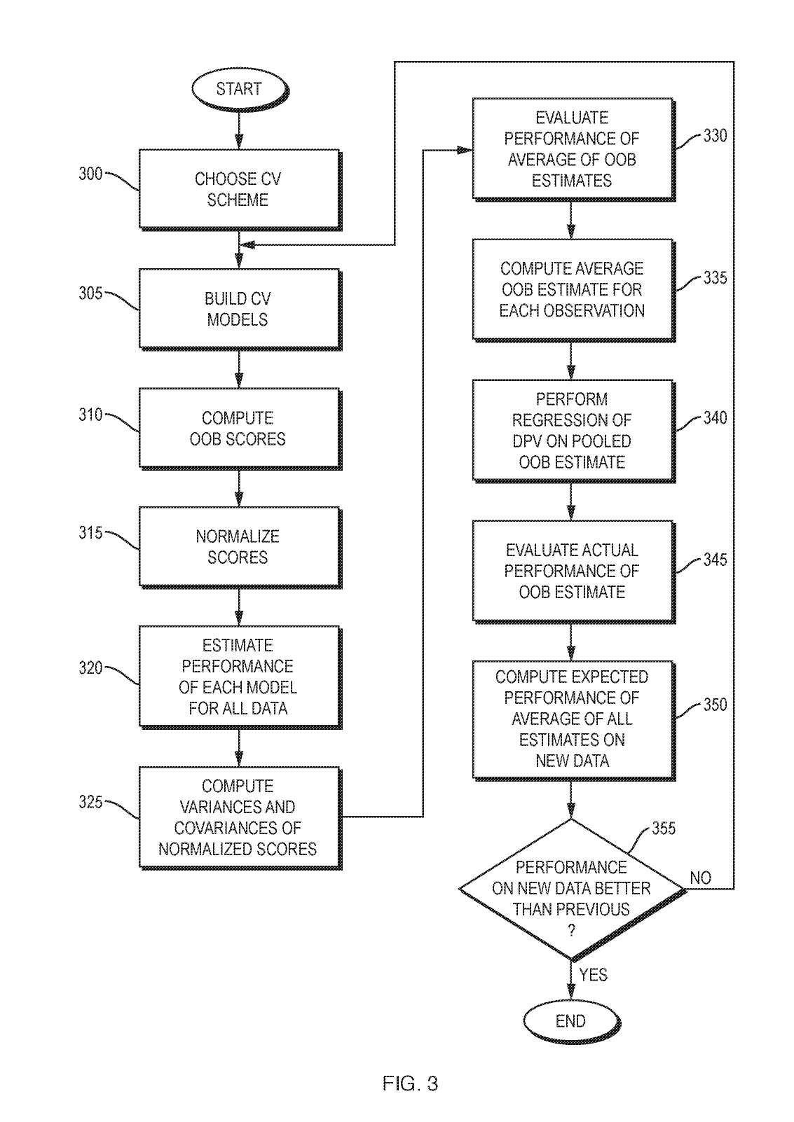

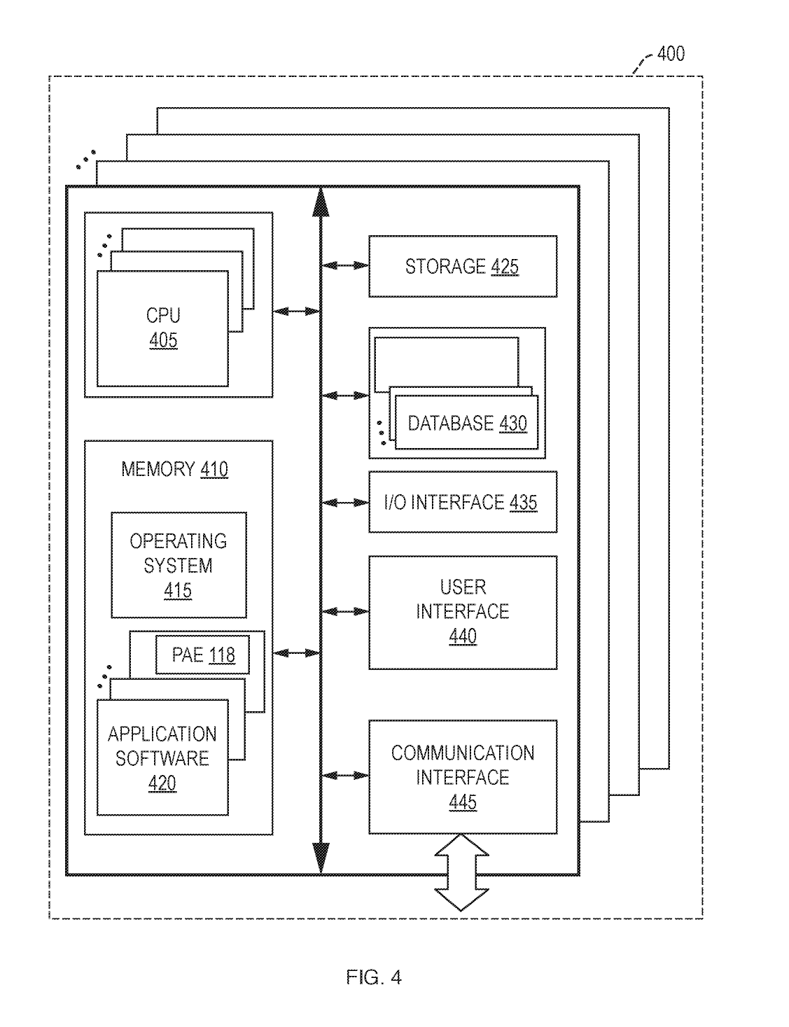

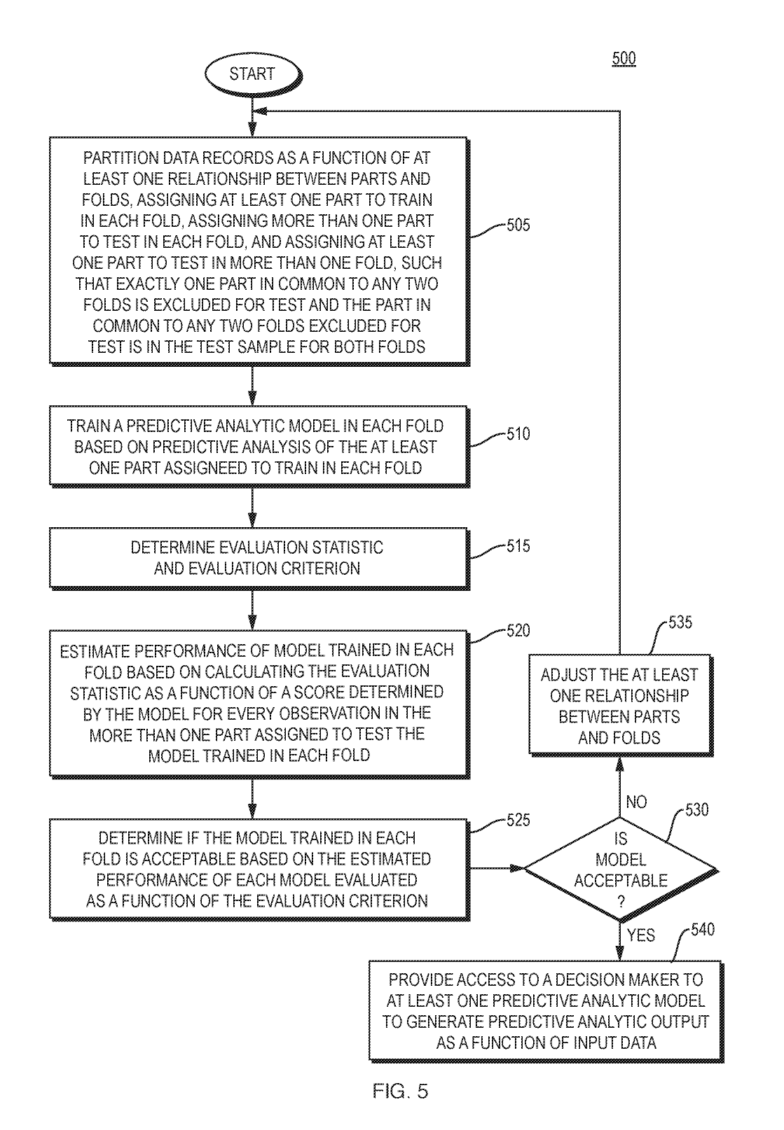

To aid understanding, this document is organized as follows. First, illustrative operational activities of an exemplary learning machine developing a predictive analytic model based on data records partitioned as a function of at least one relationship between parts and folds, assigning more than one part to test each fold, and assigning at least one part to test more than one fold, such that exactly one part in common to any two folds is excluded for testing, and the part in common to any two folds excluded for testing is in the test sample for both folds; and, evaluating the predictive analytic model based on more than one prediction determined for each observation in each test data record as a function of a predictive analytic model not trained on the test data record are briefly introduced with reference to FIG. 1. Second, with reference to FIG. 2, the discussion turns to exemplary embodiments that illustrate an exemplary learning machine developing a predictive analytic model, and providing access to a decision maker to the predictive analytic model to generate predictive analytic output as a function of input data. Specifically, the predictive analytic model is developed by an exemplary Predictive Analytic Engine (PAE), based on data records partitioned as a function of at least one relationship between parts and folds, assigning more than one part to test each fold, and assigning at least one part to test more than one fold; and evaluating the predictive analytic model based on more than one prediction determined for each observation in each test data record as a function of a predictive analytic model not trained on the test data record. Next, an exemplary process flow of an exemplary learning machine developing an exemplary ensemble model is presented with reference to FIG. 3. Then, with reference to FIG. 4, the structure of an exemplary learning machine is presented. Finally, with reference to FIGS. 5-7, exemplary Predictive Analytic Engine (PAE) process flows are presented to explain improvements in the automatic construction and evaluation of predictive analytic models.

FIG. 1 depicts an operational activity diagram of an exemplary learning machine developing a predictive analytic model based on data records partitioned as a function of at least one relationship between parts and folds, assigning more than one part to test each fold, and assigning at least one part to test more than one fold, such that exactly one part in common to any two folds is excluded for testing, and the part in common to any two folds excluded for testing is in the test sample for both folds; and, evaluating the predictive analytic model based on more than one prediction determined for each observation in each test data record as a function of a predictive analytic model not trained on the test data record. The operational activity depicted in FIG. 1 is given from the perspective of the Predictive Analytic Engine (PAE) 118 executing as program instructions on CPU 405, depicted in FIG. 4. In FIG. 1, the CPU 405 accesses a database 105 containing data records 110. Each data record may include one or more observation 115. The Predictive Analytic Engine (PAE) 118 executes Cross-validation Plan Generation Engine 120 and Part-to-Fold Relationship Generator 125 on CPU 405 to adapt parameters including Galois Field Symmetry relationships 130, Latin Square/Latin Cube/Latin Hypercube designs 135, Evaluation Criteria 140, and Core Parameters 142, to determine a Cross-validation plan 145. In the depicted embodiment, the Cross-validation plan 145 is determined as a function of Core Parameters 142. In the depicted embodiment, the Core Parameters 142 include M defined as M=p̂k, where p is a prime number, k is any integer >0, where a Galois field of size M exists. In an illustrative example, the Cross-validation plan 145 may define the number of parts, the number of folds, the assignment of parts to train each fold, and the assignment of parts to test each fold. In various implementations, the CPU 405 may adapt the Cross-validation plan 145 to assign more than one part to test each fold, and assign at least one part to test more than one fold. In some designs, Cross-validation plan 145 may be adapted by the Cross-validation Plan Generation Engine 120 to evaluate the predictive analytic model based on more than one prediction determined for each observation in each test data record, as a function of a predictive analytic model not trained on the test data record. In an illustrative example, the Cross-validation Plan Generation Engine 120 may determine the Cross-validation plan 145 as a function of a core parameter M defined as M=p̂k, where p is a prime number, k is any integer >0, and the number of parts and folds will be M̂2+M+1, where a Galois field of size M exists. In this illustrative example, each part is left out for test M+1 times in total and each fold leaves out M+1 parts for test. For p=2 and k=1, M=p̂k=2̂1=2, M̂2±m±1=7 to obtain 7 parts and 7 folds. In the illustrated embodiment, the CPU 405 divides records 110 into parts and folds according to the Cross-validation plan 145 to create a Part-Fold Relationship 155, in which for this illustrative example, each part is left out M+1=3 times, and each fold leaves out M+1=3 parts for testing thus including 4 parts out of the 7 total parts for training. In this illustrative example of a Part-Fold Relationship 155, for p=2 and k=1, M=p̂k=2̂1=2, M̂2+M+1=7, and there are 7 parts and 7 folds. In this illustrative example of a Part-Fold Relationship 155, each of the seven parts is used to test a model exactly three times; thus, part 1 is left out of folds 1,3 and 5 and part 2 is left out of folds 1, 4, and 6, obtaining three “out of sample” or test set predictions for each record in the data. In this illustrative example, 3/7 of the data or almost 43% is reserved for test in each fold. In the depicted embodiment, the CPU 405 constructs 165 a separate predictive analytic model 160 in each fold, by predictive analysis of the parts assigned to train in each fold, and evaluation of each predictive analytic model based on the parts assigned to test each fold. In an illustrative example, the CPU 405 trains one or more fold-specific model 160 based on parts assigned to train in each fold, and evaluates the fold-specific models 160 based on more than one prediction for each test observation by a model not trained on that observation. In some examples, one or more fold-specific model 160 may be employed 170 by the CPU 405 to generate one or more prediction based on applying unseen or new data to one or more fold-specific model 160. In some embodiments, the CPU 405 may adapt 173 the construction of the one or more predictive analytic model 160 to push the complexity of fold-specific model 160 training to overfitting constrained by common complexity in an ensemble. In various examples, the complexity of one or more fold-specific model 160 may be pushed to a degree that would be overfitting in a single model, but not in an ensemble. In some designs, the CPU 405 may combine 177 the fold-specific models 160 into an ensemble model. In some implementations, the ensemble model may be a Gradient Boosting Machine (GBM) 180, with the fold-specific overfitting averaged out. In various examples, the ensemble model may be any predictive analytic model that can be sequentially constructed based on iterative predictive analysis, evaluation, and adaptation of model parameters or evaluation criteria. In some embodiments, the CPU 405 may evaluate 183 the Gradient Boosting Machine (GBM) 180 based on pairs of predictions by fold-specific models 160. In some examples, the Gradient Boosting Machine (GBM) 180 may be employed 185 by the CPU 405 to generate one or more prediction based on applying unseen or new data to the Gradient Boosting Machine (GBM) 180. In some embodiments, the CPU 405 may invert 187 the roles of the learn and test parts defined by the Part-Fold Relationship 155, to obtain smaller learn samples in each fold. In various implementations, obtaining smaller learn samples in each fold may allow a fold-specific model 160 to be learned entirely on one server 190 for efficient analysis of “big data” 195. In this illustrative example, the inverted Part-Fold Relationship 155 would have three parts making up any learn sample and four parts making up each test sample. Inverting plans can be very helpful when dealing with large data sets as the smaller learn samples in each fold can save substantial compute time. For example, in an M=11 plan which generates 133 parts and folds, and assigns M+1=12 parts for test in each fold, inverting the plan would allocate just 12 parts out of 133 in each fold for training. Various designs may include a network of multiple such servers 190 in which each server 190 hosts data useful for predictive analysis entirely on the server for training in a given fold or set of folds. Other plans could allocate tiny fractions of the data to a fold to be learned entirely on one server 190 for efficient analysis of “big data” 195.

FIG. 2 depicts an exemplary process flow of an exemplary Predictive Analytic Engine (PAE) developing a predictive analytic model. The method depicted in FIG. 2 is given from the perspective of the Predictive Analytic Engine (PAE) 118 executing as program instructions on CPU 405, depicted in FIG. 4. In some embodiments, the Predictive Analytic Engine (PAE) 118 may execute as a cloud service communicatively coupled to system services, hardware resources, or software elements local to and/or external to learning machine 400. The depicted method 200 begins with the CPU 405 partitioning at step 205 data records as a function of at least one relationship between parts and folds, assigning parts to train and test in each fold. The method continues with the CPU 405 assigning at step 210 more than one part to test each fold and assigning at least one part to test more than one fold. At step 215, the CPU 405 trains a predictive analytic model based on predictive analysis of the parts assigned to train in each fold. The method continues at step 220, with the CPU 405 evaluating the predictive analytic model based on more than one prediction determined for each observation in each test data record as a function of a predictive analytic model not trained on the test data record. At step 225, a test is performed by the CPU 405 to determine if the predictive analytic model is acceptable based on predetermined evaluation criteria. At step 230, upon a determination the predictive analytic model is not acceptable, the CPU 405 adjusts the at least one relationship between parts and folds, and the method continues at step 205. At step 235, upon a determination the predictive analytic model is acceptable, the CPU 405 provides access to a decision maker to the predictive analytic model for generation of predictive analytic output as a function of input data.

FIG. 3 depicts an exemplary process flow of an exemplary Predictive Analytic Engine (PAE) developing an ensemble model. The method depicted in FIG. 3 is given from the perspective of the Predictive Analytic Engine (PAE) 118 executing as program instructions on CPU 405, depicted in FIG. 4. In FIG. 3, at step 300, the CPU 405 chooses a Cross-validation (CV) scheme. In some embodiments, the CV scheme may define one or more relationship between parts and folds. In various implementations, the one or more relationship between parts and folds may determine the number of parts, the number of folds, the assignment of parts to train each fold, and the assignment of parts to test each fold. In some designs, the number of parts, the number of folds, the assignment of parts to train each fold, and the assignment of parts to test each fold, may be based on Galois Field mathematics. In an illustrative example, the number of parts, the number of folds, the assignment of parts to train each fold, and the assignment of parts to test each fold, may be based on a Latin Square. In some examples, the number of parts, the number of folds, the assignment of parts to train each fold, and the assignment of parts to test each fold, may be based on a Latin Cube. In various embodiments, the number of parts, the number of folds, the assignment of parts to train each fold, and the assignment of parts to test each fold, may be based on a Latin Hypercube. In some examples, the number of parts, the number of folds, the assignment of parts to train each fold, and the assignment of parts to test each fold, may be based on a combinatorics-based J-Choose-K design. At step 305, the CPU 405 builds CV models separately on each fold. At step 310, the CPU 405 computes Out of Bag (OOB) scores for each model, determined as a function of data held “out of bag”, and reserved for test. In some embodiments, more than one score may be determined for each observation based on more than one prediction determined for each observation in each test data record as a function of a predictive analytic model not trained on the test data record. At step 315, the CPU 405 normalizes the OOB scores. At step 320, the CPU 405 estimates the performance of each model for all the OOB or test data. At step 325, the CPU 405 computes variances and co-variances of the normalized scores. In various implementations, a variance or covariance may be computed based on more than one test prediction for every observation in the training data, determined as a function of a predictive analytic model not trained on the test data observation. At step 330, the CPU 405 evaluates the performance of the average of the OOB estimates as a function of a pooled OOB estimate. At step 335, the CPU 405 computes the average OOB estimate for each observation, based on more than one test prediction for every observation in the training data, determined as a function of a predictive analytic model not trained on the test data observation. At step 340, the CPU 405 performs a regression analysis of the dependent variable (DPV) on the pooled OOB estimate. At step 345, the CPU 405 evaluates the actual performance of the pooled OOB estimate for all the OOB or test data. At step 350, the CPU 405 computes the expected performance of the average of all OOB estimates on new data. In various implementations, the expected performance of the average of all OOB estimates on new data may be determined for more than one prediction per test data observation, by pairs of models not trained on the observation. At step 355, the CPU 405 performs a test to determine if the model performance on new data is better than the previous model. Upon a determination that the model performance on new data is not better than the previous model, the method continues at step 305 to build CV models. In some designs, at least one relationship between parts and folds may be adjusted before continuing to build CV models. Upon a determination the model performance on new data is better than the previous model, the method ends.

FIG. 4 depicts a structural view of an exemplary learning machine having a Predictive Analytic Engine (PAE). In FIG. 4, an exemplary learning machine 400 includes a CPU 405 that is in electrical communication with memory 410. The depicted memory 410 also includes data and program instructions to implement Operating System 415, Application Software 420, and Predictive Analytic Engine (PAE) 118. In some embodiments, Application Software 420 may include Predictive Analytic Engine (PAE) 118. The CPU 405 is communicatively coupled to Storage 425 to store data and retrieve data. The CPU 405 is communicatively coupled to Database 430 to access, store, and retrieve database records. The CPU 405 is communicatively coupled to I/O Interface 435 to receive system input and provide system output. The CPU 405 is communicatively coupled to User Interface 440 to receive user input and provide user output. The CPU 405 is configured to communicate with network entities via Communication Interface 445.

FIG. 5 depicts an exemplary process flow of an exemplary Predictive Analytic Engine (PAE) developing a predictive analytic model. The method depicted in FIG. 5 is given from the perspective of the Predictive Analytic Engine (PAE) 118 executing as program instructions on CPU 405, depicted in FIG. 4. In some embodiments, the Predictive Analytic Engine (PAE) 118 may execute as a cloud service communicatively coupled to system services, hardware resources, or software elements local to and/or external to learning machine 400. The depicted method 500 begins with the CPU 405 at step 505, partitioning data records as a function of at least one relationship between parts and folds, assigning at least one part to train in each fold, assigning more than one part to test in each fold, and assigning at least one part to test in more than one fold, such that exactly one part in common to any two folds is excluded for test and the part in common to any two folds excluded for test is in the test sample for both folds. The method continues at step 510 with the CPU 405 training a predictive analytic model in each fold based on predictive analysis of the at least one part assigned to train in each fold. The method continues at step 515 with the CPU 405 determining an evaluation statistic and evaluation criterion. The method continues at step 520 with the CPU 405 estimating the performance of a model trained in each fold based on calculating the evaluation statistic as a function of a score determined by the model for every observation in the more than one part assigned to test the model trained in each fold. The method continues at step 525 with the CPU 405 determining if the model trained in each fold is acceptable based on the estimated performance of each model evaluated as a function of the evaluation criterion. At step 530 a test is performed by the CPU 405 to determine if each model is acceptable, based on the estimated performance of each model determined by the CPU 405 at step 525. Upon a determination by the CPU 405 at step 530 the model is not acceptable, the method continues at step 535 with the CPU 405 adjusting the at least one relationship between parts and folds, and the method continues at step 505, with the CPU 405 partitioning data records as a function of at least one relationship between parts and folds, assigning at least one part to train in each fold, assigning more than one part to test in each fold, and assigning at least one part to test in more than one fold, such that exactly one part in common to any two folds is excluded for test and the part in common to any two folds excluded for test is in the test sample for both folds. Upon a determination by the CPU 405 at step 530 the model is acceptable, the method continues at step 540 with the CPU 405 providing access to a decision maker to at least one predictive analytic model to generate predictive analytic output as a function of input data.

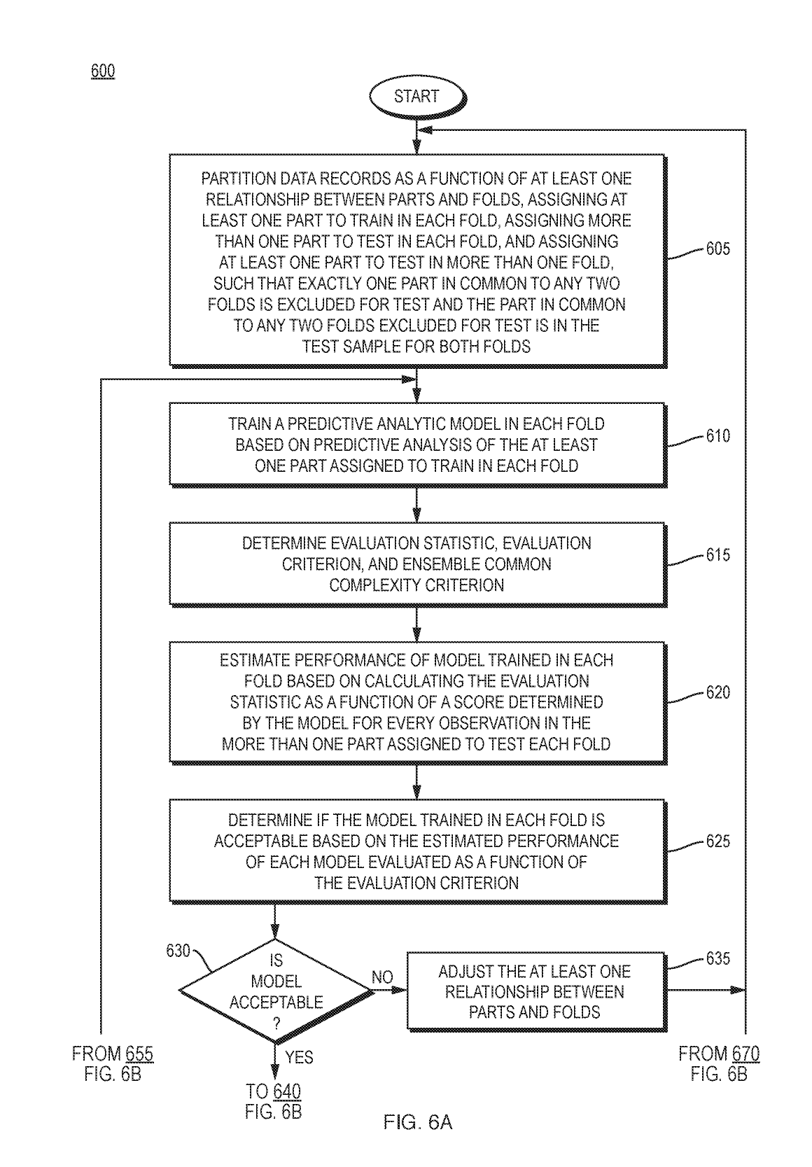

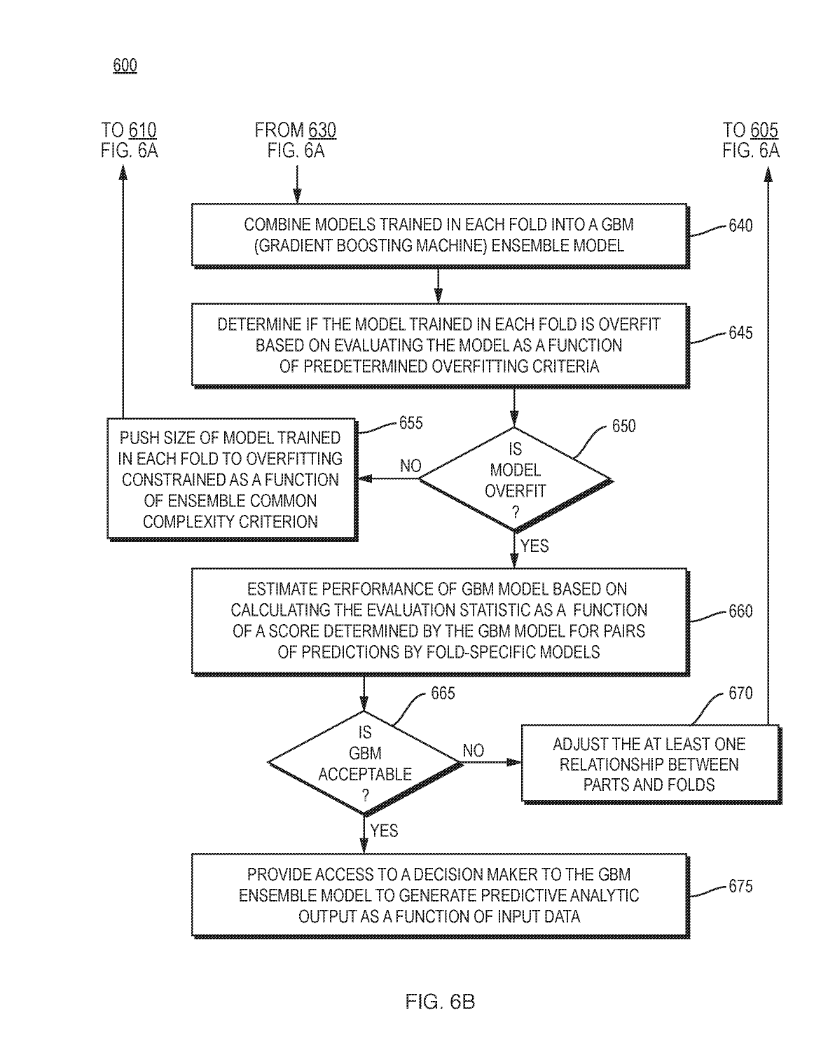

FIG. 6 depicts an exemplary process flow of an exemplary Predictive Analytic Engine (PAE) developing a predictive analytic model. The method depicted in FIG. 6 is given from the perspective of the Predictive Analytic Engine (PAE) 118 executing as program instructions on CPU 405, depicted in FIG. 4. In some embodiments, the Predictive Analytic Engine (PAE) 118 may execute as a cloud service communicatively coupled to system services, hardware resources, or software elements local to and/or external to learning machine 400. The depicted method 600 begins with the CPU 405 at step 605 partitioning data records as a function of at least one relationship between parts and folds, assigning at least one part to train in each fold, assigning more than one part to test in each fold, and assigning at least one part to test in more than one fold, such that exactly one part in common to any two folds is excluded for test and the part in common to any two folds excluded for test is in the test sample for both folds. The method continues at step 610 with the CPU 405 training a predictive analytic model in each fold based on predictive analysis of the at least one part assigned to train in each fold. The method continues at step 615 with the CPU 405 determining an evaluation statistic, evaluation criterion, and ensemble common complexity criterion. The method continues at step 620 with the CPU 405 estimating the performance of the model trained in each fold based on calculating the evaluation statistic as a function of a score determined by the model for every observation in the more than one part assigned to test each fold. The method continues at step 625 with the CPU 405 determining if the model trained in each fold is acceptable based on the estimated performance of each model evaluated as a function of the evaluation criterion. At step 630, a test is performed by the CPU 405 to determine if each model is acceptable based on the estimated performance evaluated for each model at step 625. Upon a determination the estimated performance of each model is not acceptable, the method continues at step 635 with the CPU 405 adjusting the at least one relationship between parts and folds, and the method continues at step 605 with the CPU 405 partitioning data records as a function of at least one relationship between parts and folds, assigning at least one part to train in each fold, assigning more than one part to test in each fold, and assigning at least one part to test in more than one fold, such that exactly one part in common to any two folds is excluded for test and the part in common to any two folds excluded for test is in the test sample for both folds. Upon a determination the estimated performance of each model is acceptable, the method continues at step 640 with the CPU 405 combining models trained in each fold into a GBM (Gradient Boosting Machine) Ensemble Model. In some embodiments, the CPU 405 at step 640 may combine models trained in each fold into any type of model that can be constructed and evaluated based on sequential predictive analysis. The method continues at step 645 with the CPU 405 determining if the model trained in each fold is overfit based on evaluating the model as a function of predetermined overfitting criteria. At step 650, a test is performed by the CPU 405 to determine if the model is overfit, based on the model evaluation performed by the CPU 405 at step 645. Upon a determination at step 650 the model is not overfit, the method continues at step 655 with the CPU 405 pushing the size of model trained in each fold to overfitting constrained as a function of ensemble common complexity criterion, and the method continues at step 610 with the CPU 405 training a predictive analytic model in each fold based on predictive analysis of the at least one part assigned to train in each fold. Upon a determination at step 650 the model is overfit, the method continues at step 660 with the CPU 405 estimating performance of the GBM Model based on calculating the evaluation statistic as a function of a score determined by the GBM Model for pairs of predictions by fold-specific models. In some embodiments, the CPU 405 at step 660 may estimate the performance of any type of model that can be constructed and evaluated based on sequential predictive analysis. At step 665, a test is performed by the CPU 405 to determine if the model is acceptable, based on the estimated model performance evaluated at step 660. Upon a determination at step 665 the model is not acceptable, the method continues at step 670 with the CPU 405 adjusting the at least one relationship between parts and folds, and the method continues at step 605 with the CPU 405 partitioning data records as a function of at least one relationship between parts and folds, assigning at least one part to train in each fold, assigning more than one part to test in each fold, and assigning at least one part to test in more than one fold, such that exactly one part in common to any two folds is excluded for test and the part in common to any two folds excluded for test is in the test sample for both folds. Upon a determination at step 665 the model is acceptable, the method continues at step 675 with the CPU 405 providing access to a decision maker to the GBM Ensemble Model to generate predictive analytic output as a function of input data.

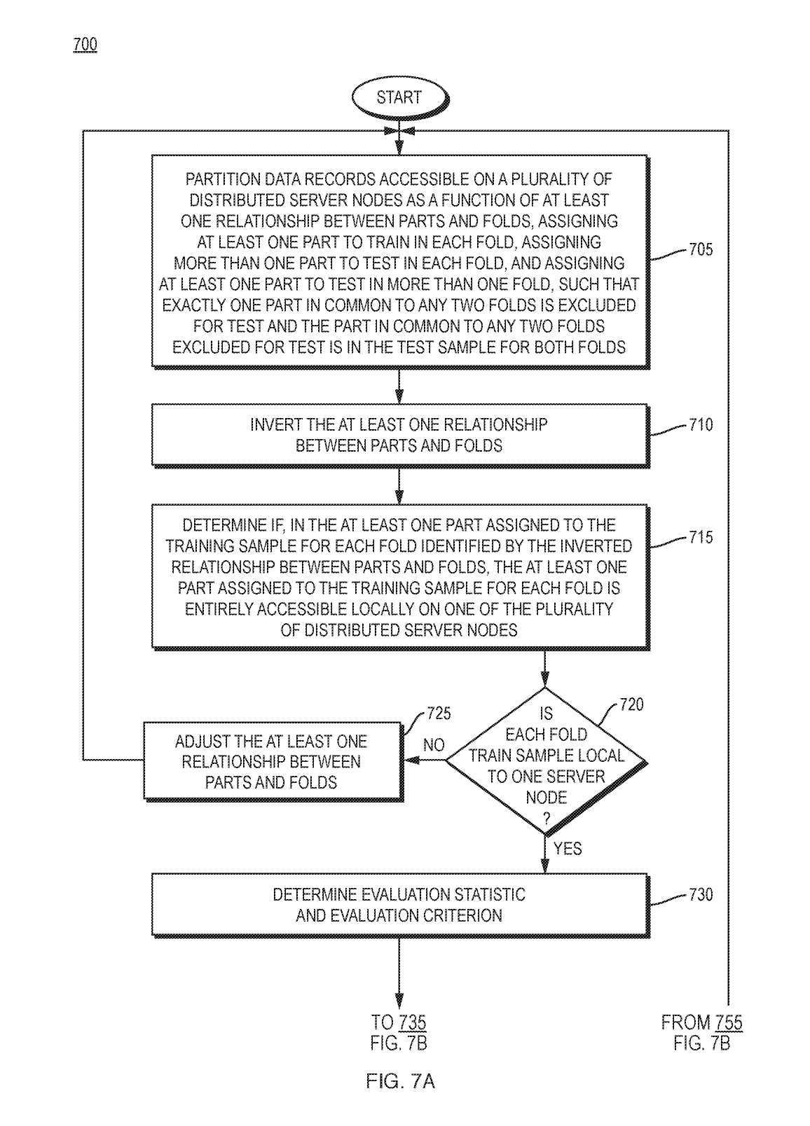

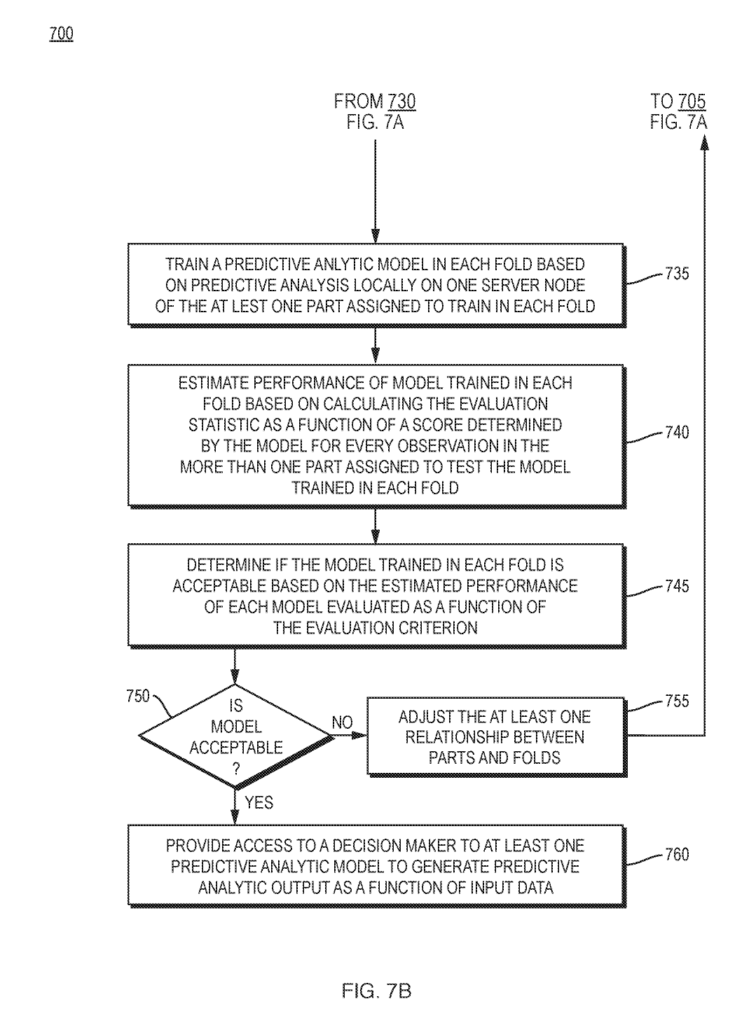

FIG. 7 depicts an exemplary process flow of an exemplary Predictive Analytic Engine (PAE) developing a predictive analytic model. The method depicted in FIG. 7 is given from the perspective of the Predictive Analytic Engine (PAE) 118 executing as program instructions on CPU 405, depicted in FIG. 4. In some embodiments, the Predictive Analytic Engine (PAE) 118 may execute as a cloud service communicatively coupled to system services, hardware resources, or software elements local to and/or external to learning machine 400. The depicted method 700 begins with the CPU 405 at step 705 partitioning data records accessible on a plurality of distributed server nodes as a function of at least one relationship between parts and folds, assigning at least one part to train in each fold, assigning more than one part to test in each fold, and assigning at least one part to test in more than one fold, such that exactly one part in common to any two folds is excluded for test and the part in common to any two folds excluded for test is in the test sample for both folds. The method continues at step 710 with the CPU 405 inverting the at least one relationship between parts and folds. In some embodiments, the CPU 405 may invert the assignment of data records to train and test such that, in the inverted relationship: any part initially assigned to train is assigned to test; and, any part initially assigned to test is assigned to train. The method continues at step 715 with the CPU 405 determining if, in the at least one part assigned to the training sample for each fold identified by the inverted relationship between parts and folds, the at least one part assigned to the training sample for each fold is entirely accessible locally on one of the plurality of distributed server nodes. At step 720 a test is performed by the CPU 405 to determine if each fold train sample is local to one server node, based on the determination by the CPU 405 at step 715. Upon a determination by the CPU 405 at step 720 each fold train sample is not local to one server node, the method continues at step 725 with the CPU 405 adjusting the at least one relationship between parts and folds, and the method continues at step 705 with the CPU 405 partitioning data records accessible on a plurality of distributed server nodes as a function of at least one relationship between parts and folds, assigning at least one part to train in each fold, assigning more than one part to test in each fold, and assigning at least one part to test in more than one fold, such that exactly one part in common to any two folds is excluded for test and the part in common to any two folds excluded for test is in the test sample for both folds. Upon a determination by the CPU 405 at step 720 each fold train sample is local to one server node, the method continues at step 730 with the CPU 405 determining an evaluation statistic and evaluation criterion. The method continues at step 735 with the CPU 405 training a predictive analytic model in each fold based on predictive analysis locally on one server node of the at least one part assigned to train in each fold. The method continues at step 740 with the CPU 405 estimating the performance of a model trained in each fold based on calculating the evaluation statistic as a function of a score determined by the model for every observation in the more than one part assigned to test the model trained in each fold. The method continues at step 745 with the CPU 405 determining if the model trained in each fold is acceptable based on the estimated performance of each model evaluated as a function of the evaluation criterion. At step 750, a test is performed by the CPU 405 to determine if the a model trained in any fold is acceptable, based on the estimated performance of each model evaluated by the CPU 405 at step 745. Upon a determination by the CPU 405 at step 750 a model is not acceptable, the method continues at step 755 with the CPU 405 adjusting the at least one relationship between parts and folds, and the method continues at step 705 with the CPU 405 partitioning data records accessible on a plurality of distributed server nodes as a function of at least one relationship between parts and folds, assigning at least one part to train in each fold, assigning more than one part to test in each fold, and assigning at least one part to test in more than one fold, such that exactly one part in common to any two folds is excluded for test and the part in common to any two folds excluded for test is in the test sample for both folds. Upon a determination by the CPU 450 at step 750 each model is acceptable, the method continues at step 760 with the CPU 405 providing access to a decision maker to at least one predictive analytic model to generate predictive analytic output as a function of input data.

Although various embodiments have been described with reference to the Figures, other embodiments are possible. For example, the present disclosure, which we refer to as Trident, relates to data partitioning and data analysis in general. More specifically, the invention relates to systems and methods for optimal data partitioning and improved data analysis in the fields of data mining, machine learning, business analytics, and predictive analytics.

In some embodiments, Trident may be used to develop an ideal type of cross validation (CV) that has unique features not available in standard cross validation. In Trident the data is divided into parts (which may be as small as one observation (row of data) or one feature (column of data). The parts are mutually exclusive and collectively exhaustive and thus include either all the rows of a data set (when the parts correspond to rows of data) or all of the columns of a data set (when the parts correspond to columns of data).

Various examples concern parts corresponding to rows of data. These parts are arranged in sets which we call folds, where each fold contains a strict subset of parts. In general, the training of a learning machine is conducted separately on each fold and the results of all such training are then combined in a variety of ways, some of which are unique to trident.

In some examples, the parts may consist of one or more observations (rows of data). In such situations, as in conventional cross-validation, a fold consists of a subset of parts which are used to train a learning machine. The resulting trained model may then used to make predictions for the parts excluded from that fold, allowing the modeler to assess the quality and accuracy of the trained model. In conventional cross-validation, each part is excluded from training or “left out” exactly one time; thus, if the data has been arranged into K parts then there must be K folds, each fold consisting of K−1 parts for training and leaving one part out for testing. In conventional cross-validation a part is left out of one and only one fold. In some embodiments of trident, by contrast, we leave out more than one part from each fold. Also, in various embodiments of trident, each part is left out more than one time, meaning that each part is left out of more than fold. This approach to data partition allows for powerful and efficient new ways to assess predictive model quality. Trident also provides remarkably efficient ways to build ensembles of models for “Big Data” (data distributed across several servers) and allows for optimal construction of ensembles of predictive models. In an illustrative example, if we use trident to also develop a Trident-final model it will not be a single model trained on all of the learn data as it is in conventional CV. Instead, the Trident-final model is an optimally re-weighted ensemble of each the models trained on the separate folds.

Some Trident embodiments may be used to develop an ideal type of cross validation that has important additional features not available in standard cross validation. In standard cross-validation the training data is divided into K mutually exclusive and collectively exhaustive parts and each part is used as a test or validation sample exactly one time. When there are K parts in standard cross-validation we speak of K folds, and the number of parts always equals the number of folds. A fold corresponds to the building of a model on K−1 parts of data and testing that model on the remaining one part of data. In standard cross-validation there is thus a one-to-one correspondence between parts and folds; if we have K parts then we must have K folds and vice versa. Also, because the parts are mutually exclusive there can be no overlap of test data across folds. In classical cross-validation each record appears in a test part exactly one time and any two test partitions are mutually exclusive. At the conclusion of a conventional cross-validation run we have one prediction available for each record in the data generated by a model that did not use that record in its training.

In some embodiments of Trident we do not have a one-to one correspondence between parts and folds. Instead, in various embodiments, a given fold will assign several parts for testing, and two different folds can use some of the same parts for testing. Thus, in various Trident designs, a part will appear in a test partition more than once, and in one very specific implementation of Trident each part will appear in a test sample exactly three times and the number of folds will depend on the specific parameters generating the design. The pattern of leaving a part out three times is especially useful because it provides three test predictions for every record in the training data and thus permits a basic estimate of the variance of those predictions. However, various embodiment Trident designs allow for a broad range of partitioning plans and a part may be left out many more than three times. At the conclusion of a Trident CV run we will have several predictions for each record in the data such that each prediction was generated by a model that did not use that record in its training. Essential to Trident is how the parts and folds are organized. Trident is designed to achieve an ideal balance of data across parts and folds to support efficient estimates of the variability of the predictions made for every record in the training data. Parts and folds are also optimally balanced so that an ideal ensemble can be created from the collection of models generated during Trident CV.

Traditional cross-validation allows us to divide the data into any number of parts between 2 and N where N is the number of records in the data. If we divide the data into just two parts then we have two-fold cross validation, and this is clearly the smallest number of parts possible allowing for both a training and a test partition. In 2-fold cross-validation we build two models, one on each partition, and each model is tested using the data in the other partition. We can of course divide the data into 3, 4, or more parts, resulting in 3, 4, or more models. Among the most common partitioning schemes are 10-fold cross-validation in which the data is divided into approximately 10 equal sized parts, and N-fold, where each record in the data is a part, and we must thus build N models. In Trident, there is less flexibility in the choice of the number of parts and folds. Technically, the number of parts and folds are determined by mathematics derived from Galois number theory. For example, in one form of Trident we would be able to choose among different plans with 7, 13, 31, 57, or 133 parts in the plans (or other larger numbers), but we would not have the option of using a plan that for example has 10 parts. (There are ways to adapt a Trident plan so that it can be used with a smaller number of parts, but this involves some compromises which we discuss further below). We present the formulas for determining various Trident cross-validation plans below.

In this document we principally discuss three variations of the Trident plans:

Trident type I, based on two dimensional Latin squares which are extended via Galois number theory;

Trident type III, a general extension of orthogonal Latin squares and Galois number theory to 3 or more dimensions; and

Trident type II, a special case of Trident Type III which we discuss in detail because of its practical applicability.

The basic characteristics of each type of Trident plan are shown in Table 1 and the definitions of the characteristic parameters are as follows:

Number of folds: these are much like folds of cross-validation

Number of parts: mutually exclusive and collectively exhaustive partitions of the data (parts can refer to either rows or columns of data)

Number of parts per fold: determined by the type of Trident

Number of part repeats in the plan (how many times a part appears in the plan, also determined by the Trident type)

In an exemplary deployment of Trident, a data analyst or an automated data analysis system may specify preferred values for any or even all of these parameters (folds, parts, repeats). Trident plans naturally generate deterministic combinations of parameter values. For example, one class of Trident plans always include as many folds as parts and three repetitions of each part across different folds. Other Trident plans naturally repeat parts M times where M is a prime number. If the specific deployment requires a combination of parameters inconsistent with the Trident mathematics a straightforward procedure is available to create an optimal compromise plan. These topics are explicated further below.

The following sections provide the details of Trident plans in general.

TABLE 1
Trident Type Characteristics

| | | | No. of parts | Part |
|---|---|---|---|---|
| Trident type | No. of folds | No. of parts | per fold | frequency |
| I | M² + M + 1 | M² + M + 1 | M + 1 | M + 1 |
| II | $\frac{{2}^{q + 1} - 1}{( 2 - 1 )}$ | $\frac{( {2}^{q - 1} ) \times ( {2}^{q + 1} - 1 )}{( {2}^{2} - 1 ) \times ( 2 - 1 )}$ | $\frac{{2}^{q} - 1}{( 2 - 1 )}$ | 3 |
| III-Hypercube | $\frac{{M}^{q - 1} ( {M}^{q} - 1 )}{( M - 1 )}$ | M^{q} | M | $\frac{( {M}^{q} - 1 )}{( M - 1 )}$ |
| III-Augmented | $\frac{( {M}^{q - 1} - 1 ) \times ( {M}^{q + 1} - 1 )}{( {M}^{2} - 1 ) \times ( M - 1 )}$ | $\frac{{M}^{q + 1} - 1}{( M - 1 )}$ | M + 1 | $\frac{{M}^{q} - 1}{( M - 1 )}$ |

In Table 1, M=p̂k where p is a prime number and k is any integer >0, and q is an integer, q>=3 the hypercube dimension.

Trident Type I Mathematics

For Trident plans of type I we start with a core parameter M defined as M=p̂k where p is a prime number and k is any integer >0. The number of parts and folds in a Trident type I plan will be shown below to be M*(M+1)+1 or M̂2+M+1. Also, each part is left out M+1 times in total and each fold leaves out M+1 parts. Since M must follow the formula M=p̂k Trident type I plans are limited to specific numbers of parts and folds and specific numbers of parts left out of each fold and specific numbers of folds a given part is left out of. For p=2 and k=1, M=p̂k=2̂1=2, M̂2+M+1=7 to obtain 7 parts and 7 folds. Using the first few prime numbers 2,3,5,7 for p and setting k=1 we obtain plans with parts and folds equal to 7, 13, 31, 57, 133, and so on. The 133 part Trident type I (based on M=11) would be closest to traditional 10-fold cross-validation in that by leaving out M+1 or 12 parts in every fold would we be leaving out 12/133 or about 9% of the data for testing in each fold. This 133-fold plan would involve much more computation than conventional 10-fold cross-validation but yields important benefits such as making multiple test predictions available for each part as discussed below. Trident plans do not necessarily require more computation than conventional cross-validation. Other Trident plans using much less computation than conventional cross-validation are described below when we introduce Trident type III plans.

To illustrate these embodiments, we begin with the simplest possible Trident type I plan consisting of seven parts and seven folds. Given p=2, k=1, and thus M=2, the plan contains M̂2+M+1=7 parts and the same number of folds, each part is left out M+1=3 times, and each fold leaves out M+1=3 parts thus including 4 parts out of the 7 total parts. In this particular Trident Type I example, the data is divided into seven mutually exclusive and collectively exhaustive parts in the same way we would divide the data for conventional cross-validation. In the table below, we display how the parts are assigned to training and testing in each fold. Observe that we reserve three parts in each fold for testing, and thus allow four parts for training. This is not a general characteristic of Trident but is specific to this particular plan. In conventional cross-validation, for this example, we could also have seven folds, but six parts would be assigned to training and one part assigned to test in each fold.

The data is partitioned into seven parts numbered 1 through 7. The method by which data records are assigned to parts may be totally independent of Trident, and in some cases, may be entirely random. Typically, for predictive analytics, a dependent or target variable is distributed as similarly as possible across the parts and the parts are as similar as possible in size subject to the distribution of the dependent variable requirement.

TABLE 2
Trident I plan details: Fold/Parts assigned to test

| Fold | Parts Assigned To Test | | |
|---|---|---|---|
| 1 | 1 | 2 | 5 |
| 2 | 3 | 4 | 5 |
| 3 | 1 | 3 | 6 |
| 4 | 2 | 4 | 6 |
| 5 | 1 | 4 | 7 |
| 6 | 2 | 3 | 7 |
| 7 | 5 | 6 | 7 |

Observe that each of the seven parts is used to test a model exactly three times; thus, part 1 is left out of folds 1,3 and 5 and part 2 is left out of folds 1, 4, and 6. This means that we obtain three “out of sample” or test set predictions for each record in the data. In this example a full 3/7 of the data or almost 43% is reserved for test in each fold and this may be far more than the analyst may want. But this characterizes only the current example. Trident does not require us to reserve large fractions of the data for testing; but to reserve small fractions of data for testing we may have to partition the data into more parts than would be required for traditional cross-validation.

The seven-part plan shown above can also be inverted by exchanging the roles of the learn and test parts. If inverted, the plan would have three parts making up any learn sample and four parts making up each test sample. Inverting plans can be very helpful when dealing with large data sets as the smaller learn samples in each fold can save substantial compute time. For example, in the M=11 plan which generates 133 parts and folds, and assigns M+1=12 parts for test in each fold, inverting the plan would allocate just 12 parts out of 133 in each fold for training. Other plans could allocate tiny fractions of the data to a fold. Inverting such plans can support dramatically efficient analysis of “big data” (data that can only be stored in a distributed form across possibly hundreds or thousands of servers). An inverted plan may be selected to allow the model to be trained in any one fold to be learned entirely on one server. This would avoid the complexities of distributed computing of a learning machine and allow for massive computational savings.

Constructing a Trident Type I Plan

The simplest Trident CV plans can be generated by starting from and then modifying Latin Squares. We illustrate this here while emphasizing that Trident plans go well beyond modifications of Latin Squares. Further Trident plans cannot reasonably be used as experimental designs. We start with integers M=p̂k as defined above. This will allow us to construct a set of M+1 orthogonal Latin Squares each of size M by M. Each row of each Latin Square defines a fold so with M rows per square and M+1 orthogonal squares we obtain M*(M+1) or M̂2+M folds. Typically the parts in the Latin Square will be the parts that are “left out” for testing. When the plan is inverted the assignments instead define the folds as including rather than excluding the parts listed in the squares. We call the folds defined by a single Latin Square a “set” of folds. Orthogonal Latin Squares ensure that, in each set, the folds are mutually exclusive (no parts in common) and collectively exhaustive (each square contains all parts). Every fold in a set will have one part in common with every fold in every other set. Also, every part occurs jointly with every other part in exactly one fold. This is illustrated below.

We discuss orthogonal Latin Square construction of parts and folds to prepare for the construction of Trident plans which differ in essential ways from Latin Squares. These differences are summarized in the Table below. First, starting from the same prime numbers p and positive integers k to yield M=p̂k, instead of the Latin Square construction of M̂2 parts we obtain M̂2+M+1 parts. Thus, Trident will always have more parts than a Latin Square design. Trident type I plans always have as many parts as folds so there will also be M̂2+M+1 folds. Here we are defining folds for CV in terms of which parts are left out, so in Trident Type I each part is left out M+1 times. We next walk through process of constructing a Trident type I plan from a Latin Square.

The Latin Square design for M=3 is an M by M matrix and will have M̂2=9 parts. We also obtain M*(M+1)=12 folds which are derived from the fact that there are 4 orthogonal Latin Squares each of which defines 3 folds.

TABLE 3
Example for M = 3 orthogonal Latin squares design
Classic Latin square design for M = 3

| Fold No. | Parts of fold | | |
|---|---|---|---|
| 1 | 1 | 2 | 3 |
| 2 | 4 | 5 | 6 |
| 3 | 7 | 8 | 9 |
| 4 | 1 | 4 | 7 |
| 5 | 2 | 5 | 8 |
| 6 | 3 | 6 | 9 |
| 7 | 1 | 5 | 9 |
| 8 | 2 | 6 | 7 |
| 9 | 3 | 4 | 8 |
| 10 | 1 | 6 | 8 |
| 11 | 2 | 4 | 9 |
| 12 | 3 | 5 | 7 |

The 4 orthogonal 3×3 Latin squares stacked on top of each other

All Trident type I plans are based on a Galois field of size M, M=p̂k, where p is a prime number, and which yields the numbers for which a Galois field exists. When k=1, M=p is a prime number, and the Galois field is simply modular arithmetic mod M. Consider an ordered pair (i,j) where i and j are in the Galois field of size M. Then we can construct the Latin square folds using the following algorithm:

Algorithm for Trident Type I

1- r denotes row number (fold number) varying between 1 and M\hat{ }2+M+1
2- i denotes column number varying between 1 and M+1
3- D(r,i) denotes the i\hat{ }th part in the r\hat{ }th fold
4- Assume that we have the MxM addition and multiplication table of this
Galois field namely gs(r,i)=r.+i and gp(r,i)=r.*i where operators .+ and .*
point to the Galois field (GF(M)) addition and multiplication operation.
5- When 1<= r<=M and 1<=i<=M --->D(r,i)=i+(r−1)*M
6- When M+1<=r<=2M and 1<=i<=M --->D(r,i)=r+(i−1)*M
7- When 1<= r<=M and i=M+1 --->D(r,i)= M\hat{ }2+1

E=2M+1
ML=M\hat{ }2+2
For q=1 to M−1
{

ML=ML+1
For r=0 to M−1
{

mm=gp(r,q)
For i=0 to M−1
{

temp=gs(mm,i)+E
D(temp,r+1)=r*M+i+1

}
D(E+r,M+1)=ML

}
E=E+M

}

The logic for the algorithm of Trident type I can be explained as follows:

1. Form an M by M square. Label the elements 1 to M̂2 as follows: Number the rows and columns 0 to M−1, call the row index i and the column index j. (The elements are then M*i+j+1.) If M=3 then the first row of the first Latin square will have its elements numbered 1,2,3 and the second row elements numbered 4,5,6.

2. The first M folds are defined by one of the equations i=a, where a is 0, 1, . . . M−1 respectively for the 1st to Mth fold.

3. The remaining M̂2 folds are defined by j=b*i+a, where “*” and “+” are the multiplication and addition operations in the Galois field of size M. This is modular arithmetic when M is prime, but more complex when M=p̂k, k>1. The constants b and a range from 0 to M−1.

Starting with M̂2+M+1 parts arrange the first M̂2 parts into a Latin square. Assign one of the M+1 additional parts to all folds in a given set, for each of the M+1 sets. These are the first M̂2+M folds. Now we add one more fold consisting of the last M+1 parts. Thus the M̂2+M+1 parts are now distributed across the M̂2+M+1 folds. While this construction method is asymmetric in how the different parts are handled, the resulting set of folds is fully symmetric in how the parts enter the scheme. Below we present an example with M=3. Following the rules listed above we display the first expanded Latin square. When M=3, instead of M̂2 parts or 9 parts we will now have M̂2+M+1 or 13 parts (an additional M+1 parts). We now add a different part to each of the second, third and fourth sets (the orthogonal Latin squares) and also one final fold associated with the “extra” M+1 parts. Now every part is associated with a fold M+1 or 4 times. This is shown in table 4.
Observe that starting with an M̂2+M+1 trident design and deleting any one fold and all the parts contained in the fold leaves a Latin Square design. Thus the Trident type I design can be transformed into a Latin square design by deletion, or equivalently a Latin square design can be made into Trident type I design by augmenting the Latin square design with M+1 additional parts and one additional fold (as we did above).

Comments on Practical Implementation of the Trident Type I Plan

1. In the context of Trident for cross validation we assign data records to parts at random, subject to certain constraints. Once every record has been assigned to a part the plan is straightforward to execute: we train a model in each fold, holding back the specified parts for testing.

2. Each fold should be the same size, or as close to the same size as feasible. When it is not possible to make all folds equal in size attention must also be paid to the next point.

3. For a categorical target, the fraction of each fold that is of a given level should be the same, or as near as possible to the same across all folds. For example, with a binary target where the rarer class is present in 10% of the data, then each fold should be constructed to have as close as possible to 10% of the rare class. This may require a few folds to be quite a bit different in size than others.

Advantages of Trident Type I designs come from the fact that each pair of CV folds exclude some of the training data in common and each pair of CV folds have the same degree of overlap in the data. The trident design manages random variation so that the model built on any one CV fold is in practice nearly equally as good a model as that built on any other CV fold. Thus, the models built on each pair of CV folds have in practice nearly equal pairwise-correlation of their predictions on test data with any other pair of CV folds.

Trident Type III

The approach above has shown how to generate Trident type I designs starting from the M by M Latin Square where M is defined as p̂k with p a prime number and k a positive integer. We now describe the construction of Trident Type III designs which can be based on the Latin cube or hypercube. With a Latin Square we started with M̂2 parts and then expanded with an additional M+1 parts. In Trident type III we start with a Latin Cube containing M̂2 parts and augment it with an M̂2+M+1 Trident I design to produce an M̂3+M̂2+M+1 plan consisting of M̂3+M̂2+M+1 parts, and M̂4+M̂3+2*M̂2+M+1 folds. (Note that the 2*M̂2 term describing the number of folds). M̂4+M̂3+M̂2 folds come from the Latin cube, and a further M̂2+M+1 come from the augmenting Trident type 1 plan. To put this another way, in addition to the M̂2+M+1 folds inherent in the added Trident I plan each of those folds are added to the M̂2 folds in one of the M̂2+M+1 sets. This approach can be iterated augmenting an M̂q Latin hypercube with an augmented MÂ(q−1) plan.

One simple way to generate the Latin cube is to consider the elements of the cube to be defined by 3 indices i, j, and k. Where each index runs from 0 to M−1. The part number of each element is then p=M̂2*i+M*j+k+1, in ordinary arithmetic, not Galois field operations. For any Latin cube or hypercube each fold has M parts. At least one of the dimensions must vary from 0 to M−1. All dimensions are either fixed for a given fold, or vary from 0 to M−1. We can generate the parts in each fold in the order where one index goes 0, 1, . . . , M−1. For specificity, let that index be the last of (i, j, k) that varies from 0 to M−1. Using m as do loop variable (do m=0,M−1) we generate sets of M̂2 folds with each part occurring exactly once in each set of folds. (M̂2 folds for a Latin cube; for an M̂q Latin hyper-cube this would be M̂(q−1) folds). For a Latin cube there are (M*3−1)/(M−1)=M̂2+M+1 sets of M̂2 folds; for a M̂q hypercube, there are (M̂q−1)/M−1 sets of folds.

To expand a Latin cube to obtain the Trident type III plan:
i=a1, j=a2, k=m (One set of M̂2 folds, each fold in the set defined by setting a1 and a2 each to some number from 0 to M−1)
i=a1, j=m, k=a2 (One set of M̂2 folds, each fold in the set defined by setting a1 and a2 each to some number from 0 to M−1)
i=m, j=a1, k=a2 (One set of M̂2 folds, each fold in the set defined by setting a1 and a2 each to some number from 0 to M−1)
i=a1, j=b2*m+a2, k=m (M−1 sets of M̂2 folds, the sets defined by b2=1, . . . , M−1 each fold in the set is defined by setting a1 and a2 each to some number from 0 to M−1)
i=b1*m+a1, j=a2, k=m (M−1 sets of M̂2 folds, the sets defined by b1=1, . . . , M−1 each fold in the set is defined by setting a1 and a2 each to some number from 0 to M−1)
i=b1*m+a1, j=m, k=a2 (M−1 sets of M̂2 folds, the sets defined by b1=1, . . . , M−1 each fold in the set is defined by setting a1 and a2 each to some number from 0 to M−1)
i=b1*m+a1, j=b2*m+a2, k=m ((M−1)̂2 sets of M̂2 folds, the sets defined by b1=1, . . . , M−1, and b2=1, . . . , M−1 each fold in the set is defined by setting a1 and a2 each to some number from 0 to M−1)

One part is now added to each set. These new M̂2+M+1 parts are then used in a Trident-I design to produce M̂2+M+1 additional folds. This generates what we call a Trident-III Augmented design.

These equations divide naturally into M̂2+M+1 sets, where each member of the set differs only in the values of a. Any two of these equations drawn from two different sets define a fold. There are many ways to define the same fold. For example, (i=1, j=1) and (i=1, j=i) define the same fold. Any pair of parts occur in exactly one fold. Therefore the number of unique folds is M̂2*(M̂3−1)/(M*(M−1))=M̂2*(M̂2+M+1). The algorithm for generating the general hypercube design is shown as follows. It should be noted that each subset in the algorithm can be augmented with a single part to generate the Trident type III-augmented design.

Algorithm for Trident Type III-Hypercube

Assume q′=q−1 (q′=number of fixed dimensions)
Define a_bounds[q][2] and b_bounds[q][2]
Define S0={0,1,2,...,q−1}
For qp=q−1 to 0
{

Get all subsets of size qp out of all q elements of S0 and store them in S array
For each s in S
{

Mark dimensions of s as fixed
Mark the largest dimension that doesn't belong to s as jmax
Mark the rest of the dimensions as varying
For dim=0 to q

If dim ∈ s

a_bounds[dim][1]=0,a_bound[dim][2]=M−1, b_bound[dim][1:2]=0

else if dim ∉ s and dim=jmax

a_bounds[dim][1]=0, a_bound[dim][2]=M−1, b_bound[dim][1]=1,
b_bound[dim][2]=1

else //dim is marked as varying

a_bounds[dim][1]=0, a_bound[dim][2]=M−1, b_bound[dim][1]=1,
b_bound[dim][2]=M−1

Generate all combinations of varying a and b of all dimensions between their
bounds
For each combination such as a[:] and b[:] generate a fold:
For m=0 to M−1
{

part_no=1
For dim=q−1 to 0
{

current_b=b[dim]
current_a=a[dim]
v1= current_b.*m
index_value= current_a.+v1
part_no=part_no+index_value*M\hat{ }(q−i)

}
Fold[m]=part_no

}

}

We can elucidate the difference between a Trident Type I and Trident Type III design by comparing an 8-by-8 Latin Square starting point (64 elements) and a 4-by-4-by 4 Latin Cube starting point, also with 64 elements or parts. The M=8 Latin Square will allow us to first construct M+1 or 9 orthogonal squares (each square defining a set of folds). Each Latin square defines 8 folds and thus the 9 orthogonal Latin squares define 9×8=72 folds. Now, constructing a Trident Type I design, we add one new part to each set of folds for 9 new parts and new total of 64+9=73 parts. We also add one new fold consisting of the 9 new parts. All the other folds also contain 9 parts (8 from the original Latin Square plus the one added part). We thus have 73 parts and 73 folds, this equality being a characteristic of Trident Type I plans. Each fold now consists of 9 parts, each part is included in 9 folds, any two parts are included in exactly one fold, and any two folds have exactly one part in common. These are features of Trident type I plans not of Latin Square designs. Applied to cross-validation, the parts associated with a fold are the typically parts that are “left out” for testing although it is always possible to invert the plan and instead train on the 9 parts and test on the remaining 73−9=64 parts.

The 4-by-4-by-4 Latin Cube also starts with 64 parts and by definition M=4. Standard mathematics shows that there will M̂2+M+1=16+4+1=21 orthogonal Latin cubes. Since each row of each cube is a fold, and there are 16 rows per cube, we have 21 cubes each with 16 rows (folds) yielding 16*21=336 folds in total. This is our Latin Cube starting point. Now, as with the Latin Square, we add one new part to each of the 21 cubes, bringing us to a total of 64+21=85 parts. Our starting set of 336 folds (from the Latin cube) now each contain M+1=5 parts as we added one new part to each fold. The 21 new parts are also organized into a separate 21 part Trident Type I design, consisting of 21 parts and 21 folds, each fold consisting of 5 parts. This leads us to a grand total of 336+21=357 folds each consisting of 5 parts. This Trident Type III design has the characteristic Trident features: any two parts are included together exactly once in any fold; any two folds have exactly one part in common. The relationship between any two parts is identical to that of any two other parts and is thus different from any design based on Latin Squares or Latin Cubes. Inverting the plan would give us 85 folds and 357 parts.

An important special case of Trident type III can be constructed by fixing M=2 and varying the hypercube dimension q. We call this special case Trident Type II. Implementing the Trident type III plan requires addition and multiplication tables of the Galois field of size M that naturally requires complex computational operations. But when M=2 these operations reduce to binary addition (A operator in the C programming language) and conventional multiplication. This makes the development of a very fast implementation possible. The table below shows how parts and folds are related in Trident Type II. The Trident plans are based on M̂q starting with q=1. When M=2 and q=1 we start with the 2×2 Latin Square and get to M̂2+M+1=7 parts and folds. But unlike Trident Type I plans the number of parts is not always equal to the number of folds. As the power q increases the ratio of parts to folds increases.

TABLE 5
Trident Type II plans (M = 2, M\hat{ }q) varying values of q

| | | | Number of parts to |
|---|---|---|---|
| Q | FOLDS | PARTS | number of folds ratio |
| 1 | 7 | 7 | 1.0 |
| 2 | 15 | 35 | 2.3 |
| 3 | 31 | 155 | 5.0 |
| 4 | 63 | 651 | 10.3 |
| 5 | 127 | 2667 | 21.0 |
| 6 | 255 | 10795 | 42.3 |
| 7 | 511 | 43435 | 85.0 |
| 8 | 1023 | 174251 | 170.3 |
| 9 | 2047 | 698027 | 341.0 |
| 10 | 4095 | 2794155 | 682.3 |
| 11 | 8191 | 11180715 | 1365.0 |

In the table above we have a plan with 155 parts but only 31 folds (third row of the table). In conventional cross-validation with 155 parts we would need to train 155 models whereas in Trident Type II we only require 31 models. This important property is noted in the fourth column of table 5. As can be seen it is possible to achieve ratios of higher than 1000:1 for the number of cross validation folds with respect to the number of parts while preserving the Trident relations between parts.

The table above is for M=2 or Trident type II. Using M=3 instead leads to some extreme pairings of the number of parts and folds which can be of vital importance in the analysis of “Big Data”. M=3 and q=7 or a 3̂7 Trident type III plan yields 2,187 parts and 796,797 folds with each fold consisting of (or leaving out) 3 parts. Inverting the plan gives us 796,797 parts and 2,187 folds, each fold consisting of 1093 parts. This plan allows us to work with about ⅛th of 1 percent of the data in each fold, which facilitates work on data distributed across several hundreds or thousands of nodes in a distributed computing cluster.

There are many possible uses for such plans. When studying rare events represented as 1 in a 0/1 variable, we may wish to assign each event to its own part (along with perhaps a large number of non-events). Although the event being studied may be rare as a proportion of the total available data, the actual number of such events may not be small. For example, clicks on an internet advertisement, or fraudulent credit card transactions. In such cases, we may want a plan with several thousand or several tens of thousands of parts. Another important use of such plans is for feature selection and each part consists of one feature. Pharmaceutical, chemical, and bioinformatic studies may benefit from the use of plans with millions of parts.

A useful variation of Trident type III plans allows each part to be left out a PRIME number of times (i.e. 3, 5, 7, 11, 13, 17, and so on). As such, Trident Type III allows for a greater focus on the accurate estimation of the variance of the predictions for a given observation. Example of such a plan where each part is left out five times is shown in Table 6.

TABLE 6
Example Trident III plan, each part left out 5 times

| | | | | | |
|---|---|---|---|---|---|
| fold 1 | 1 | 2 | 3 | 4 | 17 |
| fold 2 | 5 | 6 | 7 | 8 | 17 |
| fold 3 | 9 | 10 | 11 | 12 | 17 |
| fold 4 | 13 | 14 | 15 | 16 | 17 |
| fold 5 | 1 | 5 | 9 | 13 | 18 |
| fold 6 | 2 | 6 | 10 | 14 | 18 |
| fold 7 | 3 | 7 | 11 | 15 | 18 |
| fold 8 | 4 | 8 | 12 | 16 | 18 |
| fold 9 | 1 | 6 | 11 | 16 | 19 |
| fold 10 | 2 | 5 | 12 | 15 | 19 |
| fold 11 | 3 | 8 | 9 | 14 | 19 |
| fold 12 | 4 | 7 | 10 | 13 | 19 |
| fold 13 | 1 | 7 | 12 | 14 | 20 |
| fold 14 | 2 | 8 | 11 | 13 | 20 |
| fold 15 | 3 | 5 | 10 | 16 | 20 |
| fold 16 | 4 | 6 | 9 | 15 | 20 |
| fold 17 | 1 | 8 | 10 | 15 | 21 |
| fold 18 | 2 | 7 | 9 | 16 | 21 |
| fold 19 | 3 | 6 | 12 | 13 | 21 |
| fold 20 | 4 | 5 | 11 | 14 | 21 |
| fold 21 | 17 | 18 | 19 | 20 | 21 |

Finally, we observe that when the data for training do not easily conform to the patterns required by trident there are some relatively simple methods to adjust the patterns. For example, suppose that a given data set would naturally partitioned into 100 parts and we wished to use a Trident Type III plan. We could first generate a 155 part plan and then reduce it to 100 parts and then rebalancing the plan. This will cause the plan to deviate slightly from the patterns described above, by for example, having folds with different numbers of parts, and not all parts being assigned to the same number of folds. However, by judicious adjustment, these deviations can be limited so that for example, some parts appear one extra time, and some folds contain one extra part. The impact on the statistical properties of the Trident model are expected to be minimal when such adjustments are made.

Conventional CV is designed to provide an estimate of generalization error for a statistical or machine learning model, such as classification error or area under the ROC curve, or mean-squared error. As such, conventional CV is restricted to model-overall measures; it cannot support estimates of prediction error for a specific data record. This is a short-coming that is acutely observed for decision tree models, where users want not just over-all error estimates but also error estimates that are specific to a given terminal node of the decision tree. Clearly Trident automatically generates such record specific estimates when each record is left out at least 3 times.

One interesting variation of CV which displays some of the advantages of trident is a combinatorics-based K-Choose-J approach. We first partition the data into K parts and then we systematically choose all possible J-tuples as the parts to leave out for testing. Every selection of J parts to leave out for testing also determines which parts are used for training and thus determines the fold. Conventional CV always uses K-choose-1 which naturally leads to K folds, each of which leaves out just one part. If we start with 10-part partitioning, but then assign all possible pairs of parts for testing (10-choose-2) we get 45 possible folds. Each part is paired once with each other part, and each part is assigned to a test role exactly nine times.

The K-Choose-J approach offers the advantage of providing several predictions for every record when that record is not included in training the model and thus allows us to estimate a mean and variance for such predictions. However, there is nothing optimal or balanced in this combinatoric approach.

One key advantage that Trident has over K-choose-J is that Trident generates many fewer folds while still allowing for multiple test predictions for each record. For some variations of Trident the number of parts K can be in the tens of thousands and any K-Choose-J approach would be impractical or infeasible. Instead, for example, Trident teaches us how to develop a plan that generates just 255 folds when the number of parts is about 10,000 or a plan that uses 1,023 folds when the number of parts 174,000. About 3 million parts can be managed with 4,095 folds. (These patterns of parts and folds are listed above in the table for Trident plans of Type III with M=2.) Massive numbers of parts are important when the goal of the analysis is feature selection (for example, in bioinformatic gene analysis) and the ability to work with moderate numbers of folds is mandatory. With the K-Choose-2 combinatoric approach, by contrast, we reach 4,950 folds when we have just 100 parts. A Trident plan allowing for about 5,000 folds could handle almost 3 million parts and would thus be about 30,000 times more efficient than K-Choose-2.

Related work has been discussed in “Linear Model Selection by Cross-Validation” Author(s): Jun Shao, Journal of the American Statistical Association, Vol. 88, No. 422 (June, 1993), pp. 486-494. Shao also observes that a K-Choose-J approach to CV will often require a very large number of runs and suggests a balanced experimental design in which each record is left out the same number of times and each pair of records is also left out the same number of times. Shao's approach is based on classical experimental design in which “parts” are the “blocks” of classical experiments and rows are the “treatments”. Shao's objective is to observe that the popular leave-one-record out CV is statistically inconsistent as training samples sizes become larger leading leave-one-record-out CV to select incorrect models, and to show that “leave-many-records” out does not suffer from this defect if the number of records left out increases as the training sample increases. Shao's work is centered on the large sample properties of “leave-many-out” CV and he argues that one should never use leave-one-out CV. Shao also allows for the creation of random partitions as a method for “leave-many-out” and observes that the experimental design approach is simply one convenient alternative. By contrast, Trident is entirely about the use of new designs which are in fact not experimental designs, and the leveraging of the multiple occurrences of each record in the role of validation data. In contrast to Shao's work which is designed to avoid leave-one-out plans, leave-one-record out is an important and desirable implementation of Trident.

Richard Olshen and others have also addressed the topic of the shortcomings of conventional CV for estimating the error (not the error variance) of single classification. Olshen et. al. [reference]suggested that the misclassification rate of the tree can be better estimated by Repeated Cross validation (RCV). In RCV, conventional CV estimates are recomputed multiple times, using different random number seeds to partition the data randomly into the conventional CV folds in each repetition. Each RCV replication will yield a classification for each record which will be correct or incorrect and these can be combined to obtain the desired record-specific overall estimates of classification accuracy. Thus, RCV repeated 5 times will yield 5 test predictions for every record for a tree of any specific size. In the case of the single decision tree Trident offers a material advance over RCV, controlling randomness by maintaining a relatively small overlap in the learn sample for optimal statistical properties. Also, each observation is dealt with in a symmetric way by Trident. In RCV the realized correlations between learn samples for runs for which a given observation in test will vary randomly over a wide range. In RCV there is no way to determine the actual variance of the record specific predictions.

Post-Processing of the Trident Cross-Validation Outputs

In some embodiments, our preferred learning machine is the gradient boosting machine and several Trident innovations are especially relevant to this type of learning machine. Thus, our next paragraphs are specific to this context, however the disclosed techniques are intended to be advantageous with any model that can be constructed based on sequential predictive analysis.

The end result of a conventional cross-validation procedure is a single model trained on all (100%) of the available data. The cross-validation procedure is used to tune the parameters of the learning machine and to establish the optimal complexity of that model (number of predictors included, number of nodes in a tree, or number of trees in an ensemble, for example). One of the end results of a Trident CV is typically expected to be an ensemble model consisting of all the models built in all the folds. An essential part of the process of constructing the Trident ensemble is the determination of the common complexity of the models. When the base learning machine is a gradient boosting machine where the size of each tree (depth of each tree or the number of terminal nodes) is pre-determined, the complexity of the model is indexed by the number of trees retained in each model. The computations discussed next must be repeated for all possible sizes of models in order to find the overall optimum.

For simplicity we illustrate the construction of the Trident ensemble model for the least squares regression loss function and assume that we are examining models of a specific size (e.g. 500 trees). Let y be the dependent variable and y(i) denote an individual observation of y. Each fold produces a predicted value of y, and the balancing of parts in the Trident design guarantees that the predictions from different folds will, on average, have the same properties. Denote these predictions as yh(i,j) where i indexes observations and j indexes CV folds. For any record y(i) we can collect the specific predictions yh(i,j) for which y(i) was in a part assigned to test (“left out”). Thus, for each record y(i) we will have a set of test predictions and in practice we will want to have an equal or nearly equal number of such predictions for each record. As explained above there are Trident plans for allowing varying numbers of such test predictions and we displayed a plan where each record would be in a test partition 3 times. As Trident Type I plans leave out every record M+1 times we can elect to leave a record out M+1 times so long as M follows the definition provided for Trident Type I above.

The models generated by the gradient boosting machine are known to possibly require re-scaling and calibration. See, for example,
Caruana, R., & Niculescu-Mizil, A. (2004). Data mining in metric space: An empirical analysis of supervised learning performance criteria. Knowledge Discovery and Data Mining (KDD'04).
J. Platt. Probabilistic outputs for support vector machines and comparison to regularized likelihood methods. In A. Smola, P. Bartlett, B. Schoelkopf, and D. Schuurmans, editors, Advances in Large Margin Classifiers, pages 61-74, 1999.

One way to put this is that gradient boosting machine is capable of learning the correct predictive patterns in the data but the distribution of the scores it generates may be too narrow. Thus, it is often advisable to “normalize” or recalibrate the predictions of the gradient boosting machine. An ideal way to normalize these predictions is to run a simple (one variable) regression of y(i) on the model predictions, that is, regressing y(i) on yh(i,j) where the data for the regression consists entirely of test records. The result of this regression is an intercept and a slope which we would subsequently use to adjust all predictions made by the model. While we could do this separately for each fold, it is more efficient to pool all available test values in a single pooled regression. If each observation is left out J times, and there are N observations the number of rows of data in this calibration regression would be J*N. Since the recalibration is a simple rescaling (with a possible shift due to the intercept) the recalibration does not alter the rank order of the predictions but could spread out the predictions substantially. We denote these normalized predictions yp(i,j). Thus yp(i,j)=a+b*yh(i,j) where a is the regression estimate for the intercept and b is the regression estimate for the coefficient.

With Trident there will always be several yp's associated with any training data record and each yp will be computed in an exactly symmetrical way with respect to the data. Thus, on average, each yp should be an equally good predictor of y on new data. Furthermore, the calibration regression gives us a good estimate of how good a predictor the yp's will be on new data (the R-Squared of the recalibration regression). By construction, on average, y regressed on the yp's (not the yh's) would have a coefficient of 1.0 with an intercept of 0.0. This will hold exactly on the pooled left out data as this is the data used to fit the regression. The 0.0 intercept and 1.0 slope should hold on average on any new independent data set drawn from the same distribution as the original training data. However, while the yp's associated with different folds are exactly equally good predictors (on average), they will not be identical to each other. We can thus estimate the correlation between pairs of yp's, that is, the correlation between the different predictions made for the same observation. Because of the symmetry in the Trident plan across folds, the correlation should be the same for each pair of yp's. It is thus efficient to compute a single pooled estimate of the pairwise correlation.

For any observation y(i) we can compute its average yp from the folds that leave that observation out from model estimation, and call this average ya(i). As each observation is left out the same number of times, this will average the same number models for each observation and thus on average each yp will have the same mean and variance. Using a Trident type I plan with M=2 each record will be left out M+1=3 times. Let j1(i), j2(i) and j3(i) denote the three folds that leave out observation i. Then:

ya(i)=(yp(i,j1(i))+yp(i,j2(i))+yp(i,j3(i)))/3,

Let v=the common variance of the yp's, let c=the common covariance of pairs of yp's. We have normalized the yp's to a 1.0 coefficient, so the correlation between each yp and the dependent variable y is, on average, v. Note that so long as the yp's are not identical, c<v. Thus we have:

var(yp)=v

cov(yp,y)=v

coefficient of y on yp=v/v=1

explained variance of y on yp=v*v/v=v.

var(ya)=v/3+(2/3)*c<v

cov(ya,y)=v

coefficient of y on ya=v/(v/3+(2/3)*c)>1

explained variance of y regressed on ya=v*v/(v/3+(2/3)*c)>v.

Thus ya, the averaged recalibrated prediction, is a better predictor of y. This result is well known, and is the basis of the best way to prove Cramer-Rao bound. Furthermore we can validate this result by actually computing ya and the regression of y on ya.
This leads to the following insights:
For data that is truly out of sample we can create an ensemble of all the models developed in all the folds, simply averaging the model predictions. Let yt (t for trident) be that average. Using the 31 fold plan listed in the table above for a Trident plan with M=2, we would have 31 models in total. On new data then,

yt=(yp(i,1)+yp(i,2)+ . . . +yp(i,31))/31

var(yt)=v/31+(30/31)*c<v/3+(2/3)*c<v

cov(yt,y)=v

coefficient of y on yt=v/(v/31+(30/31)*c)>1

explained variance of y on yt=v*v/(v/31+(30/31)*c)>v*v/(v/3+(2/3)*c)>v.

Thus on new data yt is an even better predictor since we can leverage more models in the ensemble.
All of the above computations are generated for models of a given complexity, and we must repeat them for every different value of complexity available in order to determine the optimal complexity for the Trident ensemble. But the optimal number of trees for each of the predicted quantities yh, yp, ya, and yt may all be different. That is, the common optimal number of trees for the models in a Trident ensemble will depend on our objectives.

For a Trident plan with M=2, given that each observation is left out 3 times, we can use standard statistical techniques to compute and validate the equality of the v's and the c's on the same data. We can also compare the predictive performance of averaging two of the three test predictions versus predicting with ya or an individual yp to validate that Trident is correctly predicting the pattern. We can also have hold out data to validate averaging any number of yp's.

All the above also applies to models other than least squares asymptotically (e.g. binary logistic regression).

Applications

1. Clinical Data, Clinical Trials (Medicine).
Early phase clinical trial data often has few observations ranging from a few dozen to a few hundred records. Here we may want to have many times more folds then parts and the parts could reasonably contain just one observation. Multiple predictions per record could assist in the detection of anomalies and outliers as well as establishing a record-specific degree of confidence in the predictions made.

2. Forecast Error Variance or Generalization Error Variance
Let Yhat be the forecast of a predictive model. The variance of the forecast error can be decomposed into two parts:

Var(forecast error)=Var(Yhat)+E[(Y−E(Yhat))̂2].
This is the well known decomposition into the variance of the estimator and squared bias of the estimator. If we have holdout (previously unseen) data, the forecast error variance can be directly estimated as mean((Y−Yhat)̂2) on the holdout data. Test data can be used instead of holdout data so long as the model selection use of the test data has not resulted in significant fitting to the test data. However, when we want to use the best model on all the available training data conventional approaches handle forecast error variance inadequately. For example, cross validation produces an upper bound rather than a best estimate because each conventional CV fold uses less than all the data and therefore develops a fold-specific model that forecasts less accurately than would be possible using more data. Conventional CV relies on the fold-specific models to synthesize an all-data single model error variance estimate. Trident does not develop a single all-data model and its error variance estimate is for the Trident ensemble. In some cases researchers are independently interested in the lowest possible Var(Yhat) by itself even if it is derived from an ensemble. In these cases Trident is an ideal testing method and will yield best forecast error variance estimates.

3. Rare Binary Events.
In data sets with a binary dependent variable, where one outcome is rare, it is usually desirable to partition the data such that each instance of the rare outcome occurs in a different partition of the data. Also, it is desirable to produce a model using all instances of the rare outcome. Trident can ensure that each event is in a test partition multiple times and offers an ensemble model that in total makes use of every rare event.

4. Variable or Feature Selection.
Feature selection is a key part of predictive model development and in cases such as gene research the feature selection is the final objective of the research (identifying which genes are responsible for a given condition). When there are possibly hundreds of thousands or even millions of features available Trident can be used to run separate analyses on optimally partitioned subsets of features, where the subsets are created to maximize the chances of discovering important features and possibly their interactions. To use Trident for feature selection the “parts” of the method are made up of sets of features instead of sets of observations, and Trident partitions assign variables to be left out when we search for the best set of variables to use. For feature selection the models generated on the individual folds are combined in a different way and we typically would not generate a final ensemble model.

For the gradient boosting machine (GBM) or any black box technique such as a neural network, Trident offers major advantages. Trident can estimate the out of sample performance of the ensemble model consisting of all the models constructed in the separate CV folds. Further, the ensemble model is expected to be superior to any single model based on either any one of the fold-specific models, or on an all-data single model limited to a specific size as determined by the CV process. The ensemble model, which we would typically construct as a simple average of the fold-specific models, can be evaluated for every possible size of the fold-specific models. Thus, we would evaluate the ensemble consisting of all the fold-specific GBMs limited to one tree. The evaluation would of course be based on the left out data. Then, we would evaluate the ensemble performance for two-tree GBMs, and so forth, through the maximum number of trees grown. In each case, each fold-specific model would be of a common size. The expected advantage here is due to the nature of the overfitting inherent in the GBM. Any one GBM will eventually grow so large that it begins to fit more to the noise than to the signal in the data. But an average of GBMs constructed in the Trident way will succeed in averaging away much of the noise leaving mostly signal captured. This will allow us to push the fold-specific GBMs to sizes that would be overfitting in any one fold, but not when combined into an ensemble. This produces a better model efficiently and improves the model selection process from the GBM model sequence. This process requires that there is always overlap in the excluded observations between any pair of CV runs. This cannot be accomplished with standard cross-validation, or repeated cross-validation, or Shao's cross-validation.

The name Trident is inspired by the three “prongs” making up the entire Trident method.

Prong 1: Trident Uses a Sophisticated CV Scheme that has Better Properties than Conventional CV.

Trident uses an structured Galois number theory approach based to the construction of the parts and folds of a cross-validation. This means that the results are expected to vary less, and even substantially less in what is due to the random variation in the division of the data into parts and folds.
In standard cross validation there is no overlap in the data excluded from two distinct folds. This means that we have no data that can be used to estimate the statistical properties of the CV estimates when the final predictive model is applied to previously unseen data (generalization error). For example, we have no way to tell what portion of the variance of these estimates is due to the signal (i.e. var(E(Y|X)) versus variance in the estimation data (var(E(yhat(X:X_learn)|X_learn))) versus variance due to the randomness in the estimation process itself. Trident always has an overlap between the data excluded from any two folds. This gives us considerable information on the statistical properties of the CV estimates.

Prong 2: A New Predictive Model (Estimator).

The new Trident predictive model is an ensemble of the models developed with each fold. Specifically, the new estimator is a renormalized average of the fold-specific models. Note that when our learning machine is gradient boosted trees (GBM) the final trident model is also a GBM model (but larger). A single GBM model is a weighted sum of the outputs of a collection of trees. A Trident generated renormalized average of GBM models is a weighted sum of all the outputs of all the trees in all the models.
In order to understand the renormalization aspect of Trident models it is useful to consider three different estimators that could be applied to new data. (1) We could use the predictive model from any one of the Trident folds. To the extent that the Trident folds are successfully balanced these models all have an identical expected performance.
For any one of these models we need to recalibrate the predictions, for example using a simple regression (OLS for a continuous target, Logistic regression for a binary target, etc) to regress the actual target on the estimates using the excluded (test) data for that Trident fold.
A more efficient estimator uses the fact that these models are interchangeable; we can thus pool all these recalibration regressions, to get one pooled set of parameters for rescaling the Trident predictions. The log-likelihood or sum of squared errors from this regression can be used for model selection, for example, in deciding how many trees to include in the models.

Prong 3: Better Estimates of the Statistical Properties of Both the New Estimator and the Original GBM Estimator.

In Trident, each observation is left out at least twice, preferably at least three times. Furthermore, the test samples for each fold have the same overlap with each other. In the case of a categorical dependent variable this overlap is also balanced by dependent variable classes. Therefore, one can compute not only the mean value of the forecast for any single observation, but also the variance about that mean. While the variances for an individual observation will be statistically imprecise, they can be combined to estimate an average variance for any sizable subgroup of the observations, including the full data set. These averages will be much more precisely estimated.

Some embodiments may carve up a very large list of predictors into a Trident-pattern of overlapping small lists of predictors so that one model is built for every small list of predictors. In such designs, the small lists have the characteristic that any one predictor may be combined at least once with every other predictor. In an illustrative example, at the same time that the predictors (columns) are carved up by a first Trident plan, the rows can also be carved up by a second Trident plan. For example, if we have N1 short lists of variables, and N2 folds of records in the data, then we will need to run all N1 models in each of the N2 folds, resulting in N1*N2 models total. In such embodiments, once a set of such models have been developed, they can be combined in a variety of ways, including:

a) Each model may be used to make a prediction, and the results averaged;

b) running a second stage learner configured to use each model to generate a prediction YHAT for every record in a holdout data set, such that, if we have N1*N2 models, then we will have N1*N2 YHAT columns of data generated; then, running a regularized regression to predict the target as a function of the YHAT columns; and,

c) In order to determine which predictors in the original data should be used in a final model we can a model that one row of data for each model built, and with a design matrix of one predictor for every variable in the master set of predictors, coded as 1 if the variable was included as a predictor in that model and 0 otherwise, and where the artificial target for this data set is then the performance of that model on test, holdout, or OOB data; a model to predict performance is then built on this data set and this model may very well select a subset and even a very small subset of the original set of predictors as the only relevant predictors.

In an illustrative example, consider the simplest Trident plan with 7 parts, and suppose we have 700 predictors, assigning 100 predictors to each part. Each “fold” now involves using as much of the training data as we want and possibly all of it. Where the plan states “parts assigned to test” we interpret this as “predictors which we do not use in this fold”. So, fold 1 excludes predictors associated with “parts” 1,2, and 5, and fold 2 uses the same data for training as fold 1, but excludes predictors associated with “parts” 3,4, and 5.

When we have fit models to all 7 folds, we will have 7 models each using 400 of the 700 predictors. The next steps of the analysis could include; (a) creating a final ensemble model for prediction, (b) ranking each predictor by its average raw importance score in the 4 folds in which it was included, (d) modeling the performance of the model in each fold as a function of the predictors used in that model where the predictors are represented by 0/1 (absent/present) indicators.

TABLE 7
Example Trident Predictor Assignment

| | Predictors Not Used in | | |
|---|---|---|---|
| Fold | Fold | | |
| 1 | 1 | 2 | 5 |
| 2 | 3 | 4 | 5 |
| 3 | 1 | 3 | 6 |
| 4 | 2 | 4 | 6 |
| 5 | 1 | 4 | 7 |
| 6 | 2 | 3 | 7 |
| 7 | 5 | 6 | 7 |

There are a number of important observations to make here. First, we need to consider how to work with the training data available in each fold. One approach is simply to use all of the data for training although this would leave us without test data. Options include partitioning the data once into train and test and then using this partitioning for all the folds in order to arrive at at honest estimates of fold-specific model performance. We could also use any form of cross-validation including a Trident plan applied to each fold. In this case, each fold will result in the generation of multiple models which are ultimately resolved into a single model or a single performance measure. Second, the application of Trident plans to predictor selection will be most useful when the number of predictors is huge, such as encountered in gene expression data. For example, it is possible to encounter on the order of 10 million predictors when working with gene expression data, (as in SNPs in the human genome). Other exemplary applications to predictors of Trident plans need not have a specific threshold number of predictors to be useful.

Example Trident type 1 plans adapted to configure a cross-validation plan adapted to a 10 million predictor problem include the following:

TABLE 8
Example Trident type 1 plans adapted
to a 10 million predictor problem*

| | | M Trident |
|---|---|---|
| Runs (folds) | Predictors_Per_Fold | Parameter |
| 1057 | 312,205 | 32 |
| 10,303 | 99,001 | 101 |
| 262,657 | 19,532 | 512 |
| 995,007 | 10,030 | 997 |

*The numbers in the table above are determined based on Trident mathematics and would be adjusted slightly when applied to data sets where the number of variables could not be divided into exactly equal sized partitions.

In an illustrative example, in such a case, an analyst needs to decide how many predictors can reasonably and usefully tested in each run and weight this against the number of folds required. For example, should one decided to try to work with no more than about 20,000 predictors in any one run, the Trident type 1 plan with m=512 will require us to run some 262,657 models. In an illustrative example, in many bioinformatics data sets, the number of rows in the data can be rather small (500, 1000, 10000), and thus, each run can complete possibly within minutes or seconds. Ramping up 1,000 servers on a public cloud service would allow us to allocate about 262 runs per server and there are many scenarios in which the entire set of runs completes in under 24 hours. For example, running 1,000 servers in a public or private cloud is becoming increasingly common and affordable and in 2017 on Azure would be estimated to cost about $10,000.

As we pointed out above, when applying Trident to partitioning of predictors we can separately apply another and possibly very different Trident plan to the rows of the data. This could certainly be relevant to models involving text mining in the context of consumer on-line behavior where 100,000 to one million predictors might be involved in the analysis of 100 million to 1 billion persons. Applying the Trident methodology is accomplished by treating the predictor plan and the partitioning of the rows separately. Each fold involving a given subset of predictors is analyzed in a complete Trident plan, and we would apply the same plan for the rows to every fold in the plan for the predictors.

The embodiments disclosed hereinabove may be summarized as follows.

### Embodiment 1

A method to develop a predictive analytic model for predictive analytics, the method implemented on at least one processor with processor-executable program instructions configured to direct the at least one processor and at least one stored data table comprising data records useful for predictive analytics, the method comprising:

partitioning the data records into parts and folds as a function of at least one relationship between parts and folds, assigning at least one part to train in each fold, assigning more than one part to test each fold, and assigning at least one part to test more than one fold, such that exactly one part in common to any two folds is excluded for testing, and the part in common to any two folds excluded for testing is in the test sample for both folds;

constructing a predictive analytic model based on predictive analysis of the at least one part assigned to train in each fold; and,

evaluating the predictive analytic model based on more than one prediction determined for each observation in each test data record as a function of a predictive analytic model not trained on the test data record.

### Embodiment 2

The method of Embodiment 1, in which the at least one relationship between parts and folds further comprises a cross-validation plan comprising: the number of parts, the number of folds, the number of parts assigned to training, the number of parts assigned to testing, identification of the parts assigned to the training sample for each fold, and identification of the parts assigned to the testing sample for each fold.

### Embodiment 3

The method of Embodiment 2, in which partitioning the data records further comprises:
determining, based on the cross-validation plan:
   a first number of parts M that the data is to be divided into;
   a second number of folds K;
   a third number of parts J for training;
   a fourth number of parts T=M-J for testing; and,
dividing the data records into M parts, in accordance with the cross-validation plan; and,
for each fold of the K folds: assigning a first unique set of parts Pₜᵣₐᵢₙ to train in the fold, and assigning a second unique set of parts Pₜₑₛₜ to test the fold.

### Embodiment 4

The method of Embodiment 3, in which the at least one relationship between parts and folds further comprises, in combination:
(a) there is not a one-to-one correspondence between the number of parts used for training, and the number of folds;
(b) any two parts are included together exactly once in any fold;
(c) any two folds have exactly one part in common;
(d) each part is excluded from training from more than one fold and assigned to the test sample for that fold;
(e) each pair of parts is assigned to exactly one test sample;
(f) more than one part is assigned to the test sample for each fold;
(g) the set of parts assigned to the test sample for each fold is unique among the sets of parts assigned as test samples for all the folds;
(h) each part appears in a test partition more than once; and,
(i) the relationship between any two parts is identical to that of any other two parts.

### Embodiment 5

The method of Embodiment 3, in which constructing a predictive analytic model further comprises training at least one predictive analytic model, comprising: for each of the K folds, training a predictive analytic model on the parts in Pₜᵣₐᵢₙ assigned to training in the fold.

### Embodiment 6

The method of Embodiment 3, in which evaluating the predictive analytic model further comprises:
determining at least one evaluation statistic and at least one evaluation criterion for estimating the performance of a predictive analytic model;
estimating the performance of the at least one predictive analytic model, comprising: for each of the K folds, determining the estimated performance of the predictive analytic model based on calculating the at least one evaluation statistic as a function of the score determined by the predictive analytic model for every observation in the more than two parts in Pₜₑₛₜ assigned to testing for the fold;
determining if the estimated performance of the at least one predictive analytic model is acceptable based on the at least one evaluation criterion and the estimated performance of the at least one predictive analytic model;
upon a determination the estimated performance of the at least one predictive analytic model is not acceptable, adjusting cross-validation parameters, the cross-validation parameters comprising one or more of: the cross-validation plan, the evaluation statistic, or the evaluation criterion, and repeating the method; and,
upon a determination the estimated performance of the at least one predictive analytic model is acceptable, providing access to a decision maker to the at least one predictive analytic model for generating predictive analytic output as a function of input data.

### Embodiment 7

The method of Embodiment 3, in which the cross-validation plan further comprises definition of M as M=p̂k where p is a prime number and k is any integer >0.

### Embodiment 8

The method of Embodiment 3, in which the cross-validation plan further comprises the number of parts and folds equal to M*(M+1)+1 or M̂2+M+1=M̂n+M̂(n−1)+M̂0 (for n=2), each part is left out M+1 times in total, and each fold leaves out M+1 parts.

### Embodiment 9

The method of Embodiment 1, in which the at least one relationship between parts and folds further comprises a relationship between parts and folds determined based on a Galois field of size M, M=p̂k, where p is a prime number.

### Embodiment 10

The method of Embodiment 1, in which the at least one relationship between parts and folds further comprises a relationship between parts and folds determined as a function of the row and column elements of the set of orthogonal Latin Squares for which the Galois field of size M exists.

### Embodiment 11

A method to develop a predictive analytic model for predictive analytics, the method implemented on at least one processor with processor-executable program instructions configured to direct the at least one processor and at least one stored data table comprising data records useful for predictive analytics, the method comprising:

partitioning the data records into parts and folds as a function of a cross-validation plan comprising: definition of the number of parts, the number of folds, the number of parts assigned to training, the number of parts assigned to testing, identification of the parts assigned to the training sample for each fold, and identification of the parts assigned to the testing sample for each fold; such that, exactly one part in common to any two folds is excluded for testing, and the part in common to any two folds excluded for testing is in the test sample for both folds;

assigning at least one part to train in each fold, assigning more than one part to test each fold, and assigning at least one part to test more than one fold;

constructing at least one predictive analytic model based on predictive analysis of the at least one part assigned to train in each fold;

determining if the performance of the at least one predictive analytic model is acceptable based on evaluating more than one prediction determined by the at least one predictive analytic model for each observation in each test data record as a function of a predictive analytic model not trained on the test data record; and,

upon a determination the performance of the at least one predictive analytic model is acceptable, providing access to a decision maker to the at least one predictive analytic model for generating predictive analytic output as a function of input data.

### Embodiment 12

The method of Embodiment 11, in which the cross-validation plan further comprises: a first number of parts M that the data is to be divided into; a second number of folds K; a third number of parts J for training; a fourth number of parts T=M−J for testing; and, partitioning the data records further comprises: dividing the data records into M parts, in accordance with the cross-validation plan; and, for each fold of the K folds: assigning a first unique set of parts Pₜᵣₐᵢₙ to train in the fold, and assigning a second unique set of parts Pₜₑₛₜ to test the fold.

### Embodiment 13

The method of Embodiment 11, in which the cross-validation plan further comprises at least one relationship between parts and folds determined as a function of a Galois field of size M, M=p̂k, where p is a prime number, and k is any integer >0.

### Embodiment 14

The method of Embodiment 11, in which evaluating the predictive analytic model further comprises:
determining at least one evaluation statistic and at least one evaluation criterion for estimating the performance of a predictive analytic model;
estimating the performance of the at least one predictive analytic model, comprising: for each of the K folds, determining the estimated performance of the predictive analytic model based on calculating the at least one evaluation statistic as a function of the score determined by the predictive analytic model for every observation in the more than two parts in Pₜₑₛₜ assigned to testing for the fold;
determining if the estimated performance of the at least one predictive analytic model is acceptable based on the at least one evaluation criterion and the estimated performance of the at least one predictive analytic model;
upon a determination the estimated performance of the at least one predictive analytic model is not acceptable, adjusting cross-validation parameters, the cross-validation parameters comprising one or more of: the cross-validation plan, the evaluation statistic, or the evaluation criterion, and repeating the method; and,
upon a determination the estimated performance of the at least one predictive analytic model is acceptable, providing access to a decision maker to the at least one predictive analytic model for generating predictive analytic output as a function of input data.

### Embodiment 15

The method of Embodiment 11, in which:
the predictive analytic model further comprises a model that can be constructed based on sequential predictive analysis; and,
constructing the predictive analytic model further comprises:
   for each of the K folds, training a predictive analytic model on the parts in Ptrain assigned to train in the fold; and,
adapting the model size of the fold-specific models to a size that would be overfitting in any one fold, but not overfitting when the fold-specific models are combined into an ensemble model.

### Embodiment 16

The method of Embodiment 11, in which constructing the predictive analytic model further comprises:
inverting the assignment of data records to train and test such that: any part initially assigned to train is assigned to test; and, any part initially assigned to test is assigned to train; and,
for each of the K folds:
   selecting one of a plurality of servers to train in the fold; and,
training the predictive analytic model based on predictive analysis entirely on the selected server of the at least one part assigned to training for the fold as a function of the inverted assignment of data records.

### Embodiment 17

A method to develop a predictive analytic model for predictive analytics, the method implemented on at least one processor with processor-executable program instructions configured to direct the at least one processor and at least one stored data table comprising data records useful for predictive analytics, the method comprising:
partitioning the data records as a function of a first cross-validation plan into a first set of parts corresponding to columns of features within the data records such that exactly one part in common to any two folds is excluded for testing and the part in common to any two folds excluded for testing is in the test sample for both folds, and assigning the first set of parts to a first set of folds determined based on the first cross-validation plan;
partitioning the data records as a function of a second cross-validation plan into a second set of parts corresponding to rows of observations within the data records such that exactly one part in common to any two folds is excluded for testing and the part in common to any two folds excluded for testing is in the test sample for both folds, and assigning the second set of parts to a second set of folds determined based on the second cross-validation plan;
constructing a third set of folds comprising combining each of the first set of folds with each of the second set of folds, such that the third set of folds is equal in number to the product of the number of folds in the first set of folds and the number of folds in the second set of folds,
constructing a set of at least one predictive analytic model based on training a predictive analytic model in each of the third set of folds;
determining if the performance of the set of at least one predictive analytic model is acceptable based on evaluating more than one prediction determined by each predictive analytic model of the set of at least one predictive analytic model for each observation in each test data record as a function of a predictive analytic model not trained on the test data record; and,

upon a determination the performance of the set of at least one predictive analytic model is acceptable, providing access to a decision maker to the set of at least one predictive analytic model for generating predictive analytic output as a function of input data.

### Embodiment 18

The method of Embodiment 17, in which partitioning the data records further comprises any of the first and second cross-validation plans defining a relationship between parts and folds determined based on a Galois field of size M, M=p̂k, where p is a prime number.

### Embodiment 19

The method of Embodiment 17, in which the method further comprises target prediction determined as a function of a regression on a prediction by each model for every record in a holdout data set.

### Embodiment 20

The method of Embodiment 17, in which the method further comprises identifying a predictor subset of the first and second sets of parts selected as a function of the performance on test, holdout, or out-of-bag data of a subset of the predictive analytic models selected as a function of one predictor for every variable in the first and second sets of parts.

### Embodiment 21

A method to develop a predictive analytic model for predictive analytics, the method implemented on at least one processor with processor-executable program instructions configured to direct the at least one processor and at least one stored data table comprising data records useful for predictive analytics, the method comprising:
partitioning the data records into parts and folds as a function of at least one relationship between parts and folds, assigning at least one part to train in each fold, assigning more than one part to test each fold, and assigning at least one part to test more than one fold, such that exactly one part in common to any two folds is excluded for testing, and the part in common to any two folds excluded for testing is in the test sample for both folds;
constructing a predictive analytic model based on predictive analysis of the at least one part assigned to train each fold; and
evaluating the predictive analytic model based on more than one prediction determined for each observation in each test data record as a function of a predictive analytic model not trained on the test data record.

### Embodiment 22

The method of Embodiment 21 in which the at least one relationship between parts and folds further comprises a cross-validation plan determined as a function of a Galois field of size M, M=p̂k, where p is a prime number, the cross-validation plan defining at least one relationship between the number of parts, the number of folds, the parts assigned to training, and the parts assigned to testing; the at least one relationship comprising: the number of parts, the number of folds, the number of parts assigned to training, the number of parts assigned to testing, the parts assigned to the training sample for each fold, and the parts assigned to the testing sample for each fold.

### Embodiment 23

The method of Embodiment 22 in which the at least one relationship between parts and folds further comprises a cross-validation plan, the cross-validation plan defining at least one relationship between the number of parts, the number of folds, the parts assigned to training, and the parts assigned to testing; the at least one relationship comprising: the number of parts, the number of folds, the number of parts assigned to training, the number of parts assigned to testing, the parts assigned to the training sample for each fold, and the parts assigned to the testing sample for each fold, and in the at least one relationship between the number of parts, the number of folds, the parts assigned for training, and the parts assigned to testing, in combination:
(a) there is not a one-to-one correspondence between the number of parts used for training, and the number of folds;
(b) any two parts are included together exactly once in any fold;
(c) any two folds have exactly one part in common;
(d) exactly one part in common to any two folds is excluded for testing, and the part in common to any two folds excluded for testing is in the test sample for both folds;
(e) each part is excluded from training from more than one fold and assigned to the test sample for that fold;
(f) each pair of parts is assigned to exactly one test sample;
(g) more than one part is assigned to the test sample for each fold;
(h) the set of parts assigned to the test sample for each fold is unique among the sets of parts assigned as test samples for all the folds;
(i) each part appears in a test partition more than once; and
(j) the relationship between any two parts is identical to that of any other two parts.

### Embodiment 24

The method of Embodiment 23 in which partitioning the data records further comprises determining, based on the cross-validation plan: a first number of parts M that the data is to be divided into; a second number of folds K; a third number of parts J for training; a fourth number of parts T=M−J for testing; for each fold of the K folds, a first unique set of parts Pₜᵣₐᵢₙ assigned to training for the fold, and a second unique set of parts Pₜₑₛₜ assigned to testing for the fold; and, dividing the data into M parts, in accordance with the cross-validation plan.

### Embodiment 25

The method of Embodiment 24 in which constructing a predictive analytic model further comprises training at least one predictive analytic model, comprising: for each of the K folds, training a predictive analytic model on the parts in Pₜᵣₐᵢₙ assigned to training for each of the K folds.

### Embodiment 26

The method of Embodiment 25 in which evaluating the predictive analytic model further comprises:

determining at least one evaluation statistic and at least one evaluation criterion for estimating the performance of a predictive analytic model;

estimating the performance of the at least one predictive analytic model, comprising:
for each of the K folds, determining the estimated performance of the predictive analytic model based on calculating the at least one evaluation statistic as a function of the score determined by the predictive analytic model for every observation in the more than two parts in Pₜₑₛₜ assigned to testing for the fold;
determining if the estimated performance of the at least one predictive analytic model is acceptable based on the at least one evaluation criterion and the estimated performance of the at least one predictive analytic model; and
upon a determination the estimated performance of the at least one predictive analytic model is not acceptable, adjusting cross-validation parameters, the cross-validation parameters comprising one or more of: the cross-validation plan, the evaluation statistic, or the evaluation criterion, and repeating the method; and
upon a determination the estimated performance of the at least one predictive analytic model is acceptable, providing access to a decision maker to the at least one predictive analytic model for generating predictive analytic output as a function of input data.

### Embodiment 27

The method of Embodiment 26 in which the cross-validation plan further comprises the cross-validation plan being based on a core parameter M defined as M=p̂k where p is a prime number and k is any integer >0.

### Embodiment 28

The method of Embodiment 27 in which the cross-validation plan further comprises the cross-validation plan comprising the number of parts and folds equal to M*(M+1)+1 or M̂2+M+1=M̂n+M̂(n−1)+M̂0 (for n=2), each part is left out M+1 times in total, and each fold leaves out M+1 parts.

### Embodiment 29

The method of Embodiment 27 in which the cross-validation plan further comprises the cross-validation plan being derived from a Latin Square.

### Embodiment 30

The method of Embodiment 27 in which the cross-validation plan further comprises the cross-validation plan being derived from a set of M+1 orthogonal Latin Squares each of size M×M, each row of each Latin Square defining a fold, such that with M rows per square and M+1 squares yield M*(M+1) or M̂2+M folds.

### Embodiment 31

The method of Embodiment 27 in which the cross-validation plan further comprises the cross-validation plan being based on a core parameter M defined as M=p̂k where p is a prime number and k is any integer >0, and the at least one relationship between the number of parts, the number of folds, the parts assigned for training, and the parts assigned to testing being determined as a function of the row and column elements of the set of orthogonal Latin Squares for which the Galois field of size M exists.

### Embodiment 32

The method of Embodiment 27 in which the core parameter M is any non-negative integer greater than 1.

### Embodiment 33

The method of Embodiment 27 in which each fold is substantially the same size.

### Embodiment 34

The method of Embodiment 27 in which for a categorical target, the fraction of each fold that is each level is substantially the same.

### Embodiment 35

The method of Embodiment 27 in which the cross-validation plan further comprises the number of parts equal to M̂3+M̂2+M+1=M̂n+M̂(n−1)+M̂(n−2)+M̂0 (for n=3), and the number of folds equal to M̂4+M̂3+2*M̂2+M+1=M̂(n+1)+M̂n+M̂(n−1)+M̂(n−2)+M̂0 (for n=3).

### Embodiment 36

The method of Embodiment 27 in which the cross-validation plan further comprises the cross-validation plan being derived from a Latin Cube or Latin Hypercube.

### Embodiment 37

The method of Embodiment 27 in which the cross-validation plan further comprises the at least one relationship between the number of parts, the number of folds, the parts assigned for training, and the parts assigned to testing being determined as a function of the elements of the Latin Cubes or Latin Hypercubes for which the Galois field of size M exists, M=p̂k, where p is a prime number, each fold still contains M parts, each fold defined by n−1 linearly independent equations in the Galois field.

### Embodiment 38

The method of Embodiment 27 in which the cross-validation plan further comprises the at least one relationship between the number of parts, the number of folds, the parts assigned for training, and the parts assigned to testing being determined by the parts assigned for training and the parts assigned to testing being switched such that the roles of parts assigned to training and parts assigned to testing are reversed.

### Embodiment 39

The method of Embodiment 27 in which evaluating the predictive analytic model further comprises obtaining at least three predictions for each record in the data such that each prediction was generated by a model that did not use that record in its training.

### Embodiment 40

The method of Embodiment 27 in which the cross-validation plan further comprises the at least one relationship between the number of parts, the number of folds, the parts assigned for training, and the parts assigned to testing being determined based on a combinatorics-based K-Choose-J approach.

### Embodiment 41

The method of Embodiment 27 in which partitioning the data records into parts and folds further comprises partitioning the data into K parts, and systematically choosing all possible J-tuples as the parts to leave out for testing, such that every choice of which J parts to leave out for testing also determines which parts are used for training.

### Embodiment 42

The method of Embodiment 27 in which the cross-validation plan further comprises the at least one relationship between the number of parts, the number of folds, the parts assigned for training, and the parts assigned to testing being determined based on a combinatorics-based K-Choose-J approach, in which J and K are any non-negative integers.

### Embodiment 43

The method of Embodiment 27 in which the predictive analytic model is developed for feature selection, and partitioning the data records into parts and folds further comprises ensuring each part contains at least one feature.

### Embodiment 44

The method of Embodiment 27 in which the predictive analytic model is a decision tree.

### Embodiment 45

The method of Embodiment 27 in which constructing a predictive analytic model and evaluating the predictive analytic model further comprise obtaining multiple test predictions not only for each observation but also for each size of model.

### Embodiment 46

The method of Embodiment 27 in which constructing a predictive analytic model and evaluating the predictive analytic model further comprise obtaining multiple test predictions not only for each observation but also for each model complexity.

### Embodiment 47

The method of Embodiment 27 in which at least one of the at least one evaluation statistic is an arithmetic mean.

### Embodiment 48

The method of Embodiment 27 in which at least one of the at least one evaluation statistic is a standard deviation.

### Embodiment 49

The method of Embodiment 27 in which at least one of the at least one evaluation statistic is a variance.

### Embodiment 50

The method of Embodiment 27 in which at least one of the at least one evaluation statistic is a co-variance.

### Embodiment 51

The method of Embodiment 27 in which at least one of the at least one evaluation statistic is a calculation of classification error.

### Embodiment 52

The method of Embodiment 27 in which at least one of the at least one evaluation statistic is mean-squared error.

### Embodiment 53

The method of Embodiment 27 in which at least one of the at least one evaluation statistic is a calculation of area under the ROC curve.

### Embodiment 54

The method of Embodiment 27 in which the at least one predictive analytic model is a gradient boosting machine.

### Embodiment 55

The method of Embodiment 27 in which the at least one predictive analytic model is a neural network.

### Embodiment 56

The method of Embodiment 27 in which the at least one predictive analytic model is a support vector machine.

### Embodiment 57

The method of Embodiment 27 in which the at least one predictive analytic model is a perceptron.

### Embodiment 58

The method of Embodiment 27 in which the at least one predictive analytic model is an ensemble model.

### Embodiment 59

The method of Embodiment 27 in which the cross-validation plan further comprises the size of the model.

### Embodiment 60

The method of Embodiment 27 in which training at least one predictive analytic model further comprises training every possible size of the fold-specific models.

### Embodiment 61

The method of Embodiment 27 in which estimating the performance of the at least one predictive analytic model further comprises evaluating each fold-specific model at a common size.

### Embodiment 62

The method of Embodiment 27 in which at least one of the at least one evaluation statistic is a calculation of signal-to-noise ratio.

### Embodiment 64

The method of Embodiment 27 in which at least one of the at least one evaluation criterion is an expression of signal-to-noise ratio.

### Embodiment 65

The method of Embodiment 27 in which adjusting cross-validation parameters further comprises adapting the model size of the fold-specific models to a size that would be overfitting in any one fold, but not when combined into an ensemble.

### Embodiment 66

The method of Embodiment 27 in which at least one of the at least one evaluation statistic further comprises at least one correlation.

### Embodiment 67

The method of Embodiment 27 in which at least one of the at least one evaluation statistic further comprises at least one correlation between any pair of samples.

### Embodiment 68

The method of Embodiment 27 in which at least one of the at least one evaluation statistic further comprises at least one correlation between training samples for runs with a given observation in test.

### Embodiment 69

The method of Embodiment 27 in which estimating the performance of the at least one predictive analytic model further comprises normalizing at least one score determined by the at least one predictive analytic model.

### Embodiment 70

The method of Embodiment 27 in which at least one of the at least one evaluation statistic is a log-likelihood.

### Embodiment 71

The method of Embodiment 27 in which at least one of the at least one evaluation statistic is an SSE.

### Embodiment 72

The method of Embodiment 27 in which training at least one predictive analytic model further comprises sub-sampling.

### Embodiment 73

The method of Embodiment 27 in which training at least one predictive analytic model further comprises sub-sampling, and in which sub-sampling further comprises antithetic sampling.

### Embodiment 74

The method of Embodiment 27 in which the at least one predictive analytic model is developed for diagnosis of medical conditions and the data useful for predictive analytics contains data representative of clinical medical trials.

### Embodiment 75

The method of Embodiment 27 in which the at least one predictive analytic model is developed for forecast error variance or generalization error variance.

### Embodiment 76

The method of Embodiment 27 in which the at least one predictive analytic model is developed for detection of rare binary events.

### Embodiment 77

The method of Embodiment 27 in which the at least one predictive analytic model is developed for feature selection and the data useful for predictive analytics contains genomics data.

### Embodiment 78

The method of Embodiment 27 in which the at least one predictive analytic model is developed for identifying which genes are responsible for a given condition and the data useful for predictive analytics contains genomics data.

### Embodiment 79

The method of Embodiment 27 in which the cross-validation plan further comprises the learning rate of the model.

### Embodiment 80

The method of Embodiment 27 in which adjusting cross-validation parameters further comprises adapting the learning rate of the fold-specific models as a function of the resources available to train the at least one predictive analytic model.

### Embodiment 81

The method of Embodiment 21 in which partitioning the data records into parts and folds further comprises ensuring each part contains at least one observation.

### Embodiment 82

The method of Embodiment 21 in which partitioning the data records into parts and folds further comprises ensuring substantially the same degree of overlap between the data included in any two folds for training.

### Embodiment 83

The method of Embodiment 21 in which partitioning the data records into parts and folds further comprises ensuring substantially the same degree of overlap between the data included in any two folds for testing.

### Embodiment 84

The method of Embodiment 21 in which the least one relationship between parts and folds further comprises that each part will appear in a test partition at least three times.

### Embodiment 84

The method of Embodiment 21 in which the at least one relationship between parts and folds further comprises the number of parts and the number of folds determined as a function of a core parameter M defined as M=p̂k where p is a prime number and k is any integer >0.

### Embodiment 85

The method of Embodiment 21 in which the at least one relationship between parts and folds further comprises a relationship between parts and folds determined as a function of a core parameter M defined as M=p̂k where p is a prime number and k is any integer >0, and the number of parts and folds equal to M*(M+1)+1 or M̂2+M+1=M̂n+M̂(n−1)+M̂0 (for n=2), each part is left out M+1 times in total, and each fold leaves out M+1 parts.

### Embodiment 86

The method of Embodiment 21 in which the at least one relationship between parts and folds further comprises a relationship between parts and folds derived from a Latin Square.

### Embodiment 87

The method of Embodiment 21 in which the at least one relationship between parts and folds further comprises a relationship between parts and folds determined as a function of a core parameter M defined as M=p̂k where p is a prime number and k is any integer >0, and the at least one relationship between parts and folds derived from a set of M+1 orthogonal Latin Squares each of size M×M, each row of each Latin Square defining a fold, such that with M rows per square and M+1 squares yield M*(M+1) or M̂2+M folds.

### Embodiment 88

The method of Embodiment 21 in which the at least one relationship between parts and folds further comprises a relationship between parts and folds determined based on a Galois field of size M, M=p̂k, where p is a prime number.

### Embodiment 89

The method of Embodiment 21 in which the at least one relationship between parts and folds further comprises a relationship between parts and folds determined as a function of the row and column elements of the set of orthogonal Latin Squares for which the Galois field of size M exists, M=p̂k, where p is a prime number.

### Embodiment 90

The method of Embodiment 21 in which the at least one relationship between parts and folds further comprises a relationship between parts and folds determined as a function of a core parameter M defined as M=p̂k where p is a prime number and k is any integer >0, and in which the core parameter M is any non-negative integer greater than 1.

### Embodiment 91

The method of Embodiment 21 in which each fold is substantially the same size.

### Embodiment 92

The method of Embodiment 21 in which for a categorical target, the fraction of each fold that is each level is substantially the same.

### Embodiment 93

The method of Embodiment 21 in which the at least one relationship between parts and folds further comprises a relationship between parts and folds determined as a function of a core parameter M defined as M=p̂k where p is a prime number and k is any integer >0, and in which the number of parts is equal to M̂3+M̂2+M+1=M̂n+M̂(n−1)+M̂(n−2)+M̂0 (for n=3), and the number of folds is equal to M̂4+M̂3+2*M̂2+M+1=M̂(n+1)+M̂n+M̂(n−1)+M̂(n−2) M̂0 (for n=3).

### Embodiment 94

The method of Embodiment 21 in which the at least one relationship between parts and folds further comprises the relationship between parts and folds being derived from a Latin Cube or Latin Hypercube.

### Embodiment 95

The method of Embodiment 21 in which the at least one relationship between parts and folds further comprises the at least one relationship between parts and folds being determined as a function of the elements of the Latin Cubes or Latin Hypercubes for which the Galois field of size M exists, M=p̂k, where p is a prime number, each fold still contains M parts, each fold defined by n−1 linearly independent equations in the Galois field of size M.

### Embodiment 96

The method of Embodiment 21 in which the at least one relationship between parts and folds further comprises a relationship between parts and folds determined as a function of a core parameter M defined as M=p̂k where M is any non-negative integer greater than 1.

### Embodiment 97

The method of Embodiment 21 in which the at least one relationship between parts and folds further comprises: the at least one relationship between parts and folds determined as a function of a core parameter M defined as M=p̂k where p is a prime number and k is any integer >0; M̂3+M̂2+M+1 parts; and M̂4+M̂2+2*M̂2+M+1 folds.

### Embodiment 98

The method of Embodiment 21 in which the at least one relationship between parts and folds further comprises: the at least one relationship between parts and folds determined as a function of a hypercube dimension q, core parameter M defined as M=p̂k where p is a prime number and k is any integer >0; the number of parts and folds based on M̂q, and q is any integer >1.

### Embodiment 99

The method of Embodiment 21 in which the at least one relationship between parts and folds further comprises: the at least one relationship between parts and folds determined as a function of a hypercube dimension q, core parameter M defined as M=2; the number of parts and folds based on M̂q, and q is any integer >1.

### Embodiment 100

The method of Embodiment 21 in which the at least one relationship between parts and folds further comprises the at least one relationship between parts and folds further determined by the parts assigned for training and the parts assigned to testing being switched such that the roles of parts assigned to training and parts assigned to testing are reversed.

### Embodiment 100

The method of Embodiment 21 in which evaluating the predictive analytic model further comprises obtaining at least three predictions for each record in the data such that each prediction was generated by a model that did not use that record in its training.

### Embodiment 101

The method of Embodiment 21 in which the at least one relationship between parts and folds further comprises the at least one relationship between parts and folds determined based on a combinatorics-based K-Choose-J approach, in which J and K are any non-negative integers.

### Embodiment 102

The method of Embodiment 21 in which the at least one relationship between parts and folds further comprises the at least one relationship between parts and folds determined based on a combinatorics-based K-Choose-J approach in which J and K are any non-negative integers, and in which partitioning the data records into parts and folds further comprises partitioning the data into K parts, and systematically choosing all possible J-tuples as the parts to leave out for testing, such that every choice of which J parts to leave out for testing also determines which parts are used for training.

### Embodiment 103

The method of Embodiment 21 in which the at least one predictive analytic model is developed for feature selection.

### Embodiment 104

The method of Embodiment 21 in which the at least one predictive analytic model is developed for feature selection, and partitioning the data records into parts and folds further comprises ensuring each part contains at least one feature.

### Embodiment 105

The method of Embodiment 21 in which the at least one predictive analytic model is a decision tree.

### Embodiment 106

The method of Embodiment 21 in which constructing a predictive analytic model and evaluating the predictive analytic model further comprise obtaining more than one test prediction not only for each observation but also for each model complexity.

### Embodiment 107

The method of Embodiment 21 in which evaluating the predictive analytic model further comprises evaluating the predictive analytic model based on an arithmetic mean.

### Embodiment 108

The method of Embodiment 21 in which evaluating the predictive analytic model further comprises evaluating the predictive analytic model based on a standard deviation.

### Embodiment 109

The method of Embodiment 21 in which evaluating the predictive analytic model further comprises evaluating the predictive analytic model based on a variance.

### Embodiment 110

The method of Embodiment 21 in which evaluating the predictive analytic model further comprises evaluating the predictive analytic model based on a covariance.

### Embodiment 111

The method of Embodiment 21 in which evaluating the predictive analytic model further comprises evaluating the predictive analytic model based on a calculation of classification error.

### Embodiment 112

The method of Embodiment 21 in which evaluating the predictive analytic model further comprises evaluating the predictive analytic model based on mean-squared error.

### Embodiment 113

The method of Embodiment 21 in which evaluating the predictive analytic model further comprises evaluating the predictive analytic model based on calculation of area under the ROC curve.

### Embodiment 114

The method of Embodiment 21 in which the predictive analytic model is a gradient boosting machine.

### Embodiment 115

The method of Embodiment 21 in which the predictive analytic model is a neural network.

### Embodiment 116

The method of Embodiment 21 in which the predictive analytic model is a support vector machine.

### Embodiment 117

The method of Embodiment 21 in which the predictive analytic model is a perceptron.

### Embodiment 118

The method of Embodiment 21 in which the predictive analytic model is an ensemble model.

### Embodiment 119

The method of Embodiment 21 in which constructing a predictive analytic model and evaluating the predictive analytic model further comprise constructing the predictive analytic model and evaluating the predictive analytic model based on the size of the model.

### Embodiment 120

The method of Embodiment 21 in which constructing a predictive analytic model further comprises training every possible size of the fold-specific model.

### Embodiment 121

The method of Embodiment 21 in which constructing a predictive analytic model and evaluating the predictive analytic model further comprise evaluating each fold-specific predictive analytic model at a common size.

### Embodiment 122

The method of Embodiment 21 in which evaluating the predictive analytic model further comprises evaluating the predictive analytic model based on a signal-to-noise ratio.

### Embodiment 123

The method of Embodiment 21 in which evaluating the predictive analytic model further comprises evaluating the predictive analytic model based on an expression of signal-to-noise ratio.

### Embodiment 124

The method of Embodiment 21 in which constructing a predictive analytic model and evaluating the predictive analytic model further comprise adapting the model size of the fold-specific models to a size that would be overfitting in any one fold, but not when combined into an ensemble.

### Embodiment 125

The method of Embodiment 21 in which evaluating the predictive analytic model further comprises evaluating the predictive analytic model based on a correlation.

### Embodiment 126

The method of Embodiment 21 in which evaluating the predictive analytic model further comprises evaluating the predictive analytic model based on a correlation between any pair of samples.

### Embodiment 127

The method of Embodiment 21 in which evaluating the predictive analytic model further comprises evaluating the predictive analytic model based on at least one correlation between training samples for runs with a given observation in test.

### Embodiment 128

The method of Embodiment 21 in which evaluating the predictive analytic model further comprises evaluating the predictive analytic model based on normalizing at least one score determined by the predictive analytic model.

### Embodiment 129

The method of Embodiment 21 in which evaluating the predictive analytic model further comprises evaluating the predictive analytic model based on a log-likelihood.

### Embodiment 130

The method of Embodiment 21 in which evaluating the predictive analytic model further comprises evaluating the predictive analytic model based on an SSE.

### Embodiment 131

The method of Embodiment 21 in which constructing a predictive analytic model further comprises sub-sampling.

### Embodiment 132

The method of Embodiment 21 in which constructing a predictive analytic model further comprises sub-sampling and sub-sampling further comprises antithetic sampling.

### Embodiment 133

The method of Embodiment 21 in which the predictive analytic model is developed for diagnosis of medical conditions and the data records useful for predictive analytics further comprises data representative of clinical medical trials.

### Embodiment 134

The method of Embodiment 21 in which the predictive analytic model is developed for forecast error variance or generalization error variance.

### Embodiment 135

The method of Embodiment 21 in which the predictive analytic model is developed for detection of rare binary events.

### Embodiment 136

The method of Embodiment 21 in which the predictive analytic model is developed for feature selection.

### Embodiment 137

The method of Embodiment 21 in which the predictive analytic model is developed for feature selection and the data records useful for predictive analytics further comprises genomics data.

### Embodiment 138

The method of Embodiment 21 in which the predictive analytic model is developed for identifying which genes are responsible for a given condition and the data records useful for predictive analytics further comprises genomics data.

### Embodiment 139

The method of Embodiment 21 in which constructing a predictive analytic model and evaluating the predictive analytic model further comprise constructing the predictive analytic model and evaluating the predictive analytic model based on the learning rate of the model.

### Embodiment 140

The method of Embodiment 21 in which constructing a predictive analytic model and evaluating the predictive analytic model further comprise adapting the learning rate of the fold-specific models as a function of the resources available to construct or evaluate the predictive analytic model.

### Embodiment 141

The method of Embodiment 21 in which the method further comprises providing access to a decision maker to the at least one predictive analytic model for generating predictive analytic output as a function of input data.

### Embodiment 142

The method of Embodiment 21 in which evaluating the predictive analytic model further comprises determining if the predictive analytic model is acceptable based on at least one evaluation criterion, and upon a determination the estimated performance of the at least one predictive analytic model is not acceptable, adjusting the at least one relationship between parts and folds, and repeating the method.

### Embodiment 143

The method of Embodiment 21 in which the data records useful for predictive analytics are distributed across more than one server.

### Embodiment 144

The method of Embodiment 21 in which constructing a predictive analytic model further comprises predictive analysis entirely on one server of the at least one part assigned to train at least one fold.

### Embodiment 145

The method of Embodiment 21 in which constructing a predictive analytic model further comprises predictive analysis entirely on one server of all of the at least one part assigned to train at least one fold.

### Embodiment 146

The method of Embodiment 21, in which: the data records useful for predictive analytics are distributed across more than one server; the at least one relationship between parts and folds further comprises the parts assigned to training, and the parts assigned to testing determined by the parts assigned for training and the parts assigned to testing being inverted such that the roles of parts assigned to training and parts assigned to testing are reversed; and, constructing a predictive analytic model further comprises predictive analysis entirely on one server of the at least one part assigned to train at least one fold.

### Embodiment 147

The method of Embodiment 21 in which the at least one relationship between parts and folds further comprises at least one part left out for testing a prime number of times.

### Embodiment 148

The method of Embodiment 21 in which constructing a predictive analytic model further comprises constructing an ensemble model based on more than one model trained in more than one fold.

### Embodiment 149

The method of Embodiment 21 in which evaluating the predictive analytic model further comprises evaluating an ensemble model based on more than one prediction for each observation.

### Embodiment 150

The method of Embodiment 21 in which evaluating the predictive analytic model further comprises evaluating the predictive analytic model based on the size of the model.

### Embodiment 151

The method of Embodiment 21 in which constructing a predictive analytic model further comprises constructing the predictive analytic model based on the complexity of the model.

### Embodiment 152

The method of Embodiment 21 in which evaluating the predictive analytic model further comprises evaluating the predictive analytic model based on the complexity of the model.

### Embodiment 153

The method of Embodiment 21 in which constructing a predictive analytic model further comprises constructing an ensemble model based on the complexity of more than one predictive analytic model trained in more than one fold.

### Embodiment 154

The method of Embodiment 21 in which evaluating the predictive analytic model further comprises evaluating an ensemble model based on the complexity of more than one predictive analytic model trained in more than one fold.

### Embodiment 155

The method of Embodiment 21 in which constructing a predictive analytic model further comprises constructing an ensemble model based on the complexity of more than one predictive analytic model trained for more than one predictive analytic model complexity in at least one fold.

### Embodiment 156

The method of Embodiment 21 in which evaluating a predictive analytic model further comprises evaluating an ensemble model based on the complexity of more than one predictive analytic model complexity in at least one fold.

### Embodiment 157

The method of Embodiment 21 in which evaluating a predictive analytic model further comprises determining an optimal complexity of more than one predictive analytic model in at least one fold, the optimal complexity determined as a function of more than one prediction for at least one observation.

### Embodiment 158

The method of Embodiment 21 in which evaluating a predictive analytic model further comprises determining at least one correlation between more than one prediction for at least one observation, each of the more than one prediction determined by a predictive analytic model trained on a unique fold.

### Embodiment 159

The method of Embodiment 21 in which evaluating a predictive analytic model further comprises:

identifying a first subset of the more than one prediction for each observation;

identifying a second subset of the more than one prediction for each observation;

determining a first statistic as a function of the first subset of the more than one prediction for each observation;

determining a second statistic as a function of the second subset of the more than one prediction for each observation; and

comparing the first statistic to the second statistic.

### Embodiment 160

The method of Embodiment 21 in which the at least one relationship between parts and folds further comprises a symmetric relationship between the number of parts assigned to test each fold and the number of folds tested by each part assigned to test.

### Embodiment 161

The method of Embodiment 21 in which the at least one relationship between parts and folds further comprises the same number of parts assigned to test each fold as the number of folds tested by each part assigned to test.

### Embodiment 160

A system to automatically develop a predictive analytic model for predictive analytics, comprising:

one or more processor;

at least one stored data table comprising a plurality of records and a plurality of columns and including data useful for creating and evaluating a predictive model; and

a memory that is not a transitory propagating signal, the memory connected to one or more processor and encoding computer readable instructions, including processor executable program instructions, the computer readable instructions accessible to the one or more processor, wherein the processor executable program instructions, when executed by one or more processor, cause one or more processor to perform operations comprising:
partition the data records into parts and folds as a function of at least one relationship between parts and folds, assigning at least one part to train each fold, assigning more than one part to test each fold, and assigning at least one part to test more than one fold;
construct a predictive analytic model based on predictive analysis of the at least one part assigned to train each fold; and
evaluate the predictive analytic model based on more than one prediction determined for each observation in each test data record as a function of a predictive analytic model not trained on the test data record.

Applications claiming benefit of priority to this application may contain claims broader, narrower, entirely different in scope, or entirely different in subject matter, similar to, or the same as, the appended claims.

In an illustrative example in accordance with an embodiment of the present invention, the system and method are accomplished through the use of one or more computing devices. As depicted in FIGS. 1 and 4, one of ordinary skill in the art would appreciate that an exemplary computing device appropriate for use with embodiments of the present application may generally be comprised of one or more of a Central processing Unit (CPU) which may be referred to as a processor, Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to affect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While some of the foregoing drawings and description set forth functional aspects of some embodiments of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, Python, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are exemplary, and provided for illustrative disclosure of enablement and exemplary best mode of various embodiments. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A method to develop a predictive analytic model for predictive analytics, the method implemented on at least one processor with processor-executable program instructions configured to direct the at least one processor and at least one stored data table comprising data records useful for predictive analytics, the method comprising:
partitioning the data records into parts and folds as a function of at least one relationship between parts and folds, assigning at least one part to train in each fold, assigning more than one part to test each fold, and assigning at least one part to test more than one fold, such that exactly one part in common to any two folds is excluded for testing, and the part in common to any two folds excluded for testing is in the test sample for both folds;
constructing a predictive analytic model based on predictive analysis of the at least one part assigned to train in each fold; and,
evaluating the predictive analytic model based on more than one prediction determined for each observation in each test data record as a function of a predictive analytic model not trained on the test data record.

2. The method of claim 1, in which the at least one relationship between parts and folds further comprises a cross-validation plan comprising: the number of parts, the number of folds, the number of parts assigned to training, the number of parts assigned to testing, identification of the parts assigned to the training sample for each fold, and identification of the parts assigned to the testing sample for each fold.

3. The method of claim 2, in which partitioning the data records further comprises:
determining, based on the cross-validation plan:
a first number of parts M that the data is to be divided into;
a second number of folds K;
a third number of parts J for training;
a fourth number of parts T=M−J for testing; and,
dividing the data records into M parts, in accordance with the cross-validation plan; and,
for each fold of the K folds: assigning a first unique set of parts Pₜᵣₐᵢₙ to train in the fold, and assigning a second unique set of parts Pₜₑₛₜ to test the fold.

4. The method of claim 3, in which the at least one relationship between parts and folds further comprises, in combination:
(a) there is not a one-to-one correspondence between the number of parts used for training, and the number of folds;
(b) any two parts are included together exactly once in any fold;
(c) any two folds have exactly one part in common;
(d) each part is excluded from training from more than one fold and assigned to the test sample for that fold;
(e) each pair of parts is assigned to exactly one test sample;
(f) more than one part is assigned to the test sample for each fold;
(g) the set of parts assigned to the test sample for each fold is unique among the sets of parts assigned as test samples for all the folds;
(h) each part appears in a test partition more than once; and,
(i) the relationship between any two parts is identical to that of any other two parts.

5. The method of claim 3, in which constructing a predictive analytic model further comprises training at least one predictive analytic model, comprising: for each of the K folds, training a predictive analytic model on the parts in Pₜᵣₐᵢₙ assigned to training in the fold.

6. The method of claim 3, in which evaluating the predictive analytic model further comprises:
determining at least one evaluation statistic and at least one evaluation criterion for estimating the performance of a predictive analytic model;
estimating the performance of the at least one predictive analytic model, comprising: for each of the K folds, determining the estimated performance of the predictive analytic model based on calculating the at least one evaluation statistic as a function of the score determined by the predictive analytic model for every observation in the more than two parts in Pₜₑₛₜ assigned to testing for the fold;
determining if the estimated performance of the at least one predictive analytic model is acceptable based on the at least one evaluation criterion and the estimated performance of the at least one predictive analytic model;
upon a determination the estimated performance of the at least one predictive analytic model is not acceptable, adjusting cross-validation parameters, the cross-validation parameters comprising one or more of: the cross-validation plan, the evaluation statistic, or the evaluation criterion, and repeating the method; and,
upon a determination the estimated performance of the at least one predictive analytic model is acceptable, providing access to a decision maker to the at least one predictive analytic model for generating predictive analytic output as a function of input data.

7. The method of claim 3, in which the cross-validation plan further comprises definition of M as M=p̂k where p is a prime number and k is any integer >0.

8. The method of claim 3, in which the cross-validation plan further comprises the number of parts and folds equal to M*(M+1)+1 or M̂2+M+1=M̂n+M̂(n−1)+M̂0 (for n=2), each part is left out M+1 times in total, and each fold leaves out M+1 parts.

9. The method of claim 1, in which the at least one relationship between parts and folds further comprises a relationship between parts and folds determined based on a Galois field of size M, M=p̂k, where p is a prime number.

10. The method of claim 1, in which the at least one relationship between parts and folds further comprises a relationship between parts and folds determined as a function of the row and column elements of the set of orthogonal Latin Squares for which the Galois field of size M exists.

11. The method of claim 1, in which the cross-validation plan further comprises a predictor plan.

12. The method of claim 11, in which the parts excluded for testing in the fold further comprise predictors not used in the fold.

13. A method to develop a predictive analytic model for predictive analytics, the method implemented on at least one processor with processor-executable program instructions configured to direct the at least one processor and at least one stored data table comprising data records useful for predictive analytics, the method comprising:
partitioning the data records into parts and folds as a function of a cross-validation plan comprising: definition of the number of parts, the number of folds, the number of parts assigned to training, the number of parts assigned to testing, identification of the parts assigned to the training sample for each fold, and identification of the parts assigned to the testing sample for each fold; such that, exactly one part in common to any two folds is excluded for testing, and the part in common to any two folds excluded for testing is in the test sample for both folds;
assigning at least one part to train in each fold, assigning more than one part to test each fold, and assigning at least one part to test more than one fold;
constructing at least one predictive analytic model based on predictive analysis of the at least one part assigned to train in each fold;
determining if the performance of the at least one predictive analytic model is acceptable based on evaluating more than one prediction determined by the at least one predictive analytic model for each observation in each test data record as a function of a predictive analytic model not trained on the test data record; and,
upon a determination the performance of the at least one predictive analytic model is acceptable, providing access to a decision maker to the at least one predictive analytic model for generating predictive analytic output as a function of input data.

14. The method of claim 13, in which the cross-validation plan further comprises: a first number of parts M that the data is to be divided into; a second number of folds K; a third number of parts J for training; a fourth number of parts T=M−J for testing; and, partitioning the data records further comprises: dividing the data records into M parts, in accordance with the cross-validation plan; and, for each fold of the K folds: assigning a first unique set of parts Pₜᵣₐᵢₙ to train in the fold, and assigning a second unique set of parts Pₜₑₛₜ to test the fold.

15. The method of claim 13, in which the cross-validation plan further comprises at least one relationship between parts and folds determined as a function of a Galois field of size M, M=p̂k, where p is a prime number, and k is any integer >0.

16. The method of claim 13, in which evaluating the predictive analytic model further comprises:
determining at least one evaluation statistic and at least one evaluation criterion for estimating the performance of a predictive analytic model;
estimating the performance of the at least one predictive analytic model, comprising: for each of the K folds, determining the estimated performance of the predictive analytic model based on calculating the at least one evaluation statistic as a function of the score determined by the predictive analytic model for every observation in the more than two parts in Pₜₑₛₜ assigned to testing for the fold;
determining if the estimated performance of the at least one predictive analytic model is acceptable based on the at least one evaluation criterion and the estimated performance of the at least one predictive analytic model;
upon a determination the estimated performance of the at least one predictive analytic model is not acceptable, adjusting cross-validation parameters, the cross-validation parameters comprising one or more of: the cross-validation plan, the evaluation statistic, or the evaluation criterion, and repeating the method; and,
upon a determination the estimated performance of the at least one predictive analytic model is acceptable, providing access to a decision maker to the at least one predictive analytic model for generating predictive analytic output as a function of input data.

17. The method of claim 13, in which:
the predictive analytic model further comprises a model that can be constructed based on sequential predictive analysis; and,
constructing the predictive analytic model further comprises:
for each of the K folds, training a predictive analytic model on the parts in Ptrain assigned to train in the fold; and,
adapting the model size of the fold-specific models to a size that would be overfitting in any one fold, but not overfitting when the fold-specific models are combined into an ensemble model.

18. The method of claim 13, in which constructing the predictive analytic model further comprises:
inverting the assignment of data records to train and test such that: any part initially assigned to train is assigned to test; and, any part initially assigned to test is assigned to train; and,
for each of the K folds:
selecting one of a plurality of servers to train in the fold; and,
training the predictive analytic model based on predictive analysis entirely on the selected server of the at least one part assigned to training for the fold as a function of the inverted assignment of data records.

19. The method of claim 13, in which the cross-validation plan further comprises a predictor plan.

20. The method of claim 19, in which the parts excluded for testing in the fold further comprise predictors not used in the fold.

21. A method to develop a predictive analytic model for predictive analytics, the method implemented on at least one processor with processor-executable program instructions configured to direct the at least one processor and at least one stored data table comprising data records useful for predictive analytics, the method comprising:
partitioning the data records as a function of a first cross-validation plan into a first set of parts corresponding to columns of features within the data records such that exactly one part in common to any two folds is excluded for testing and the part in common to any two folds excluded for testing is in the test sample for both folds, and assigning the first set of parts to a first set of folds determined based on the first cross-validation plan;
partitioning the data records as a function of a second cross-validation plan into a second set of parts corresponding to rows of observations within the data records such that exactly one part in common to any two folds is excluded for testing and the part in common to any two folds excluded for testing is in the test sample for both folds, and assigning the second set of parts to a second set of folds determined based on the second cross-validation plan;
constructing a third set of folds comprising combining each of the first set of folds with each of the second set of folds, such that the third set of folds is equal in number to the product of the number of folds in the first set of folds and the number of folds in the second set of folds, constructing a set of at least one predictive analytic model based on training a predictive analytic model in each of the third set of folds;
determining if the performance of the set of at least one predictive analytic model is acceptable based on evaluating more than one prediction determined by each predictive analytic model of the set of at least one predictive analytic model for each observation in each test data record as a function of a predictive analytic model not trained on the test data record; and,
upon a determination the performance of the set of at least one predictive analytic model is acceptable, providing access to a decision maker to the set of at least one predictive analytic model for generating predictive analytic output as a function of input data.

22. The method of claim 21, in which partitioning the data records further comprises any of the first and second cross-validation plans defining a relationship between parts and folds determined based on a Galois field of size M, M=p̂k, where p is a prime number.

23. The method of claim 21, in which the method further comprises target prediction determined as a function of a regression on a prediction by each model for every record in a holdout data set.

24. The method of claim 21, in which the method further comprises identifying a predictor subset of the first and second sets of parts selected as a function of the performance on test, holdout, or out-of-bag data of a subset of the predictive analytic models selected as a function of one predictor for every variable in the first and second sets of parts.

25. The method of claim 21, in which the any of the first cross-validation plan or the second cross-validation plan further comprise a predictor plan.

26. The method of claim 25, in which the parts excluded for testing in the fold further comprise predictors not used in the fold.
